(19) United States
(12) Patent Application Publication
(10) Pub. No.: US 2019/0004507 A1
(43) Pub. Date: Jan. 3, 2019

(54) EQUIPMENT MANAGEMENT APPARATUS, EQUIPMENT MANAGEMENT SYSTEM, COMPUTER READABLE MEDIUM, AND EQUIPMENT MANAGEMENT METHOD

(71) Applicant: FUJI ELECTRIC CO.,LTD., Kanagawa (JP)

(72) Inventors: Takeshi DAITOU, Fussa-city (JP); Takahiro NAKAJIMA, Hino-city (JP)

(21) Appl. No.: 16/121,584

(22) Filed: Sep. 4, 2018

Related U.S. Application Data
(63) Continuation of application No. PCT/JP2017/026568, filed on Jul. 21, 2017.

(30) Foreign Application Priority Data
Sep. 1, 2016 (JP) 2016-171317
Apr. 27, 2017 (JP) 2017-088991

(51) Int. Cl. G05B 23/02

(52) U.S. Cl. CPC G05B 23/0213; G05B 23/0275; G05B 23/027

(57) ABSTRACT

An association relationship between monitoring-object by a monitoring-apparatus and maintenance-object by a maintenance-management-apparatus is difficult to understand. An equipment-management-apparatus including: equipment-database to store an association relationship between monitoring-object-devices that are monitoring-objects for at least one of a power-state and an operating-state, and maintenance-object-devices that are objects for maintenance management; a monitoring-information-acquiring-unit to acquire monitoring-information indicating at least one of a power-state and an operating-state of a monitoring-object-device from a monitoring-apparatus to monitor the monitoring-object-devices; a maintenance-management-information-acquiring-unit to acquire maintenance-management-information of a maintenance-object-device from a maintenance-management-apparatus to perform maintenance management of the maintenance-object-devices; an identifying-unit to identify, using the equipment-database, an association relationship between a first monitoring-object-device and a first maintenance-object-device out of the monitoring-object-devices and the maintenance-object-devices; and a display-control-unit to make associated monitoring-information of the first monitoring-object-device and maintenance-management-information of the first maintenance-object-device to be output to a display-apparatus is provided.

The contents of the following Japanese patent application are incorporated herein by reference:

NO. 2016-171317 filed in JP on Sep. 1, 2016,

NO. 2017-088991 filed in JP on Apr. 27, 2017, and

NO. PCT/JP2017/026568 filed on Jul. 21, 2017.

### BACKGROUND

### 1. Technical Field

The present invention relates to an equipment management apparatus, an equipment management system, a computer readable medium and an equipment management method.

### 2. Related Art

Conventionally, maintenance management apparatuses which perform maintenance management of monitoring apparatuses and/or pieces of equipment to monitor the power state or the operating state of pieces of equipment have been proposed (refer to Patent documents 1 to 6, for example).

Patent document 1: Japanese Patent No. 5517724 specification

Patent document 2: Japanese Patent No. 4764353 specification

Patent Document 3: Japanese Patent Application Publication No. 2007-293889

Patent Document 4: Japanese Patent Application Publication No. 2013-92858

Patent Document 5: Japanese Patent Application Publication No. 2011-181088

Patent Document 6: Japanese Patent No. 4937006 publication

A monitoring object by a monitoring apparatus and a maintenance object by a maintenance management apparatus are separately managed, and thus their association relationship is difficult to understand.

### SUMMARY

(Item 1)

The first aspect of the present invention may provide an equipment management apparatus. The equipment management apparatus may include equipment database to store an association relationship between a plurality of monitoring object devices that are monitoring objects for at least one of a power state and an operating state, and a plurality of maintenance object devices that are objects for maintenance management. The equipment management apparatus may include a monitoring information acquiring unit to acquire, from a monitoring apparatus to monitor the plurality of monitoring object devices, monitoring information indicating at least one of the power state and the operating state of the monitoring object device. The equipment management apparatus may include a maintenance management information acquiring unit to acquire, from a maintenance management apparatus to perform maintenance management of the plurality of maintenance object devices, maintenance management information of the maintenance object device. The equipment management apparatus may include an identifying unit to identify, using the equipment database, an association relationship between the first monitoring object device and the first maintenance object device out of the plurality of monitoring object devices and the plurality of maintenance object devices. The equipment management apparatus may include a display control unit to make associated monitoring information of the first monitoring object device with maintenance management information of the first maintenance object device to be output to the display apparatus.

(Item 2)

The equipment management apparatus may include a registered information receiving unit to receive, from the monitoring apparatus, registered information on the monitoring side which includes identification information of at least one monitoring object device that is newly registered as the monitoring object. The equipment management apparatus may include a registration processing unit to register at least one monitoring object device to the equipment database, based on the registered information on the monitoring side that is received.

(Item 3)

If at least one maintenance object device associated with at least one monitoring object device is already registered to the equipment database, the registration processing unit may associate the at least one monitoring object device with at least one maintenance object device. If at least one maintenance object device associated with at least one monitoring object device is not registered to the equipment database, the registration processing unit may register the at least one monitoring object device to a new record in the equipment database.

(Item 4)

The registration processing unit may make the user select at least one maintenance object device among the maintenance object devices that are not associated with any of the plurality of monitoring object devices, out of the plurality of maintenance object devices.

(Item 5)

The registered information receiving unit may receive, from the maintenance management apparatus, registered information on the maintenance side which includes identification information of at least one maintenance object device that is newly registered as the maintenance management object. The registration processing unit may register at least one maintenance object device to the equipment database, based on the registered information on the maintenance side that is received.

(Item 6)

The monitoring apparatus may manage database for monitoring to store information of the plurality of monitoring object devices. The maintenance management apparatus may manage maintenance management database to store information of the plurality of maintenance object devices. The registration processing unit may make the maintenance management apparatus register, to the maintenance management database, a monitoring object device that is newly registered as the monitoring object to the database for monitoring of the monitoring apparatus. The registration processing unit may make the monitoring apparatus to register, to the database for monitoring, a maintenance object device that is newly registered as the maintenance management object to the maintenance management database of the maintenance management apparatus.

(Item 7)

The database for monitoring may store the plurality of monitoring object devices in a first hierarchical structure. The maintenance management database may store the plurality of maintenance object devices in a second hierarchical structure. The equipment management apparatus may further include a hierarchy synchronization processing unit to synchronize the first hierarchical structure of the database for monitoring and the second hierarchical structure of the maintenance management database.

(Item 8)

The monitoring information acquiring unit may acquire, from the monitoring apparatus, a trigger which includes identification information of the first monitoring object device out of the plurality of monitoring object devices. The identifying unit may identify, accessing to the equipment database, the first maintenance object device that is associated with the first monitoring object device, out of the plurality of maintenance object devices. The maintenance management information acquiring unit may acquire, from the maintenance management apparatus, maintenance management information of the first maintenance object device that is identified by the identifying unit. The display control unit may make the maintenance management information of the first maintenance object device output to the display apparatus in association with the trigger.

(Item 9)

The display control unit may make an alert display to inform occurrence of a trigger output to the display apparatus. The display control unit may make the maintenance management information of the first maintenance object device output to the display apparatus, in response to receiving an instruction to display the detail of the trigger in the alert display.

(Item 10)

The display control unit may make the display apparatus display, using a plurality of windows, plural types of maintenance management information regarding one maintenance object device. The display control unit may make, according to the trigger, the maintenance management information of the first maintenance object device displayed on the display apparatus, switching the plurality of windows to display.

(Item 11)

The maintenance management information acquiring unit may acquire the maintenance management information of the first maintenance object device out of the plurality of maintenance object devices. The display control unit may make the maintenance management information of the first maintenance object device output to the display apparatus. In response to an user instruction to display monitoring information of a monitoring object device associated with the first maintenance object device when the maintenance management information of the first maintenance object device is being output to the display apparatus, the identifying unit may identify, accessing to the equipment database, the first monitoring object device that is associated with the first maintenance object device out of the plurality of monitoring object devices. The monitoring information acquiring unit may acquire, from the monitoring apparatus, monitoring information of the first monitoring object device that is identified by the identifying unit. The display control unit may make the monitoring information of the first monitoring object device displayed on the display apparatus in association with the maintenance management information of the first maintenance object device.

(Item 12)

The display control unit may provide, to the display apparatus, access information which includes identification information of the monitoring apparatus and identification information of the first monitoring object device, and make the display apparatus acquire, from the monitoring apparatus, a display to display the monitoring information of the first monitoring object device.

(Item 13)

The display control unit may make the display apparatus allowed to acquire the display by including, in the access information, authentication information to the monitoring apparatus.

(Item 14)

The display control unit may make configurable screen layout information to specify display contents, for each of a plurality of windows, displayed on the display apparatus.

(Item 15)

The display control unit may make it configurable to display, for at least one window of the plurality of windows, monitoring information of the at least one monitoring object device out of the plurality of monitoring object devices or maintenance management information of the at least one maintenance object device out of the plurality of maintenance object devices.

(Item 16)

The display control unit may make it configurable to display, for at least one window out of the plurality of windows, information that is provided by an external server connected via the Internet.

(Item 17)

The screen layout information may include information indicating web page addresses to acquire from the external server.

(Item 18)

The second aspect of the present invention may provide an equipment management system. The equipment management system may include the equipment management apparatus of the first aspect. The equipment management system may include a monitoring apparatus. The equipment management system may include a maintenance management apparatus.

(Item 19)

The third aspect of the present invention may provide a computer readable medium to store programs. The program may make a computer function as equipment database to store an association relationship between a plurality of monitoring object devices that are monitoring objects for at least one of a power state and an operating state, and a plurality of maintenance object devices that are objects for maintenance management. The program may make the computer function as a monitoring information acquiring unit to acquire, from the monitoring apparatus to monitor the plurality of monitoring object devices, monitoring information indicating at least one of the power state and the operating state of the monitoring object device. The program may make the computer function as a maintenance management information acquiring unit to acquire, from maintenance management apparatus to perform maintenance management of the plurality of maintenance object devices, maintenance management information of the maintenance object device. The program may make the computer function as a identifying unit to identify, using the equipment database, an association relationship between the first monitoring object device and the first maintenance object device out of the plurality of monitoring object devices and the plurality of maintenance object devices. The program may make the computer function as a display control unit to make associated monitoring information of the first monitoring object device and maintenance management information of the first maintenance object device to be output to the display apparatus.

(Item 20) The fourth aspect of the present invention may provide an equipment management method. The equipment management method may include making stored, in the equipment database, an association relationship between a plurality of monitoring object devices that are monitoring objects for at least one of a power state and an operating state, and a plurality of maintenance object devices that are objects for maintenance management. The equipment management method may include acquiring, from the monitoring apparatus to monitor the plurality of monitoring object devices, monitoring information indicating at least one of the power state and the operating state of the monitoring object device. The equipment management method may include acquiring, from maintenance management apparatus to perform maintenance management of the plurality of maintenance object devices, maintenance management information of the maintenance object device. The equipment management method may include identifying, using the equipment database, an association relationship between the first monitoring object device and the first maintenance object device out of the plurality of monitoring object devices and the plurality of maintenance object devices. The equipment management method may include making associated monitoring information of the first monitoring object device and maintenance management information of the first maintenance object device to be output to the display apparatus.

(Item 21) The fifth aspect of the present invention may provide an equipment management system. The equipment management system may include a power monitoring unit to monitor a power state in each of the plurality of areas. The equipment management system may include equipment database to hold an association indicating which piece of the plurality of pieces of equipment belongs to which area of the plurality of areas. The equipment management system may include a trigger generating unit to generate a trigger of equipment monitoring, according to the monitoring result of the power state in each of the plurality of areas. The equipment management system may include an equipment identifying unit, according to the trigger, to identify as object equipment, using the equipment database at least one piece of equipment belonging to an object area that has caused the trigger, out of the plurality of areas. The equipment management system may include a diagnosis information acquiring unit to acquire diagnosis information of the object equipment that is identified.

(Item 22) The equipment management system may further include a display control unit to make the diagnosis information of the object equipment that is acquired output to the display apparatus.

(Item 23) The display control unit may make an alert display to inform occurrence of a trigger output to the display apparatus. The display control unit may make the diagnosis information of the object equipment output to the display apparatus, in response to receiving an instruction to display the detail of the trigger in the alert display.

(Item 24) The display control unit may make the display apparatus display, using the plurality of windows, plural types of diagnosis information regarding one piece of equipment. The display control unit may make, in response to diagnosis information of the object equipment being acquired, diagnosis information of the object equipment displayed on the display apparatus, switching the plurality of windows to display.

(Item 25) The display control unit may further make a display indicating a power supply-demand relationship between the plurality of areas output to the display apparatus.

(Item 26) The trigger generating unit may generate the trigger, in response to power consumption of one area exceeding a preset upper limit value.

(Item 27) The power monitoring unit may monitor a power state of pieces of equipment belonging to each of the plurality of areas. The diagnosis information acquiring unit may collect diagnosis information except the power state from a diagnosis information storage unit that is held by each of the plurality of pieces of equipment.

(Item 28) The equipment management system may include an energy management system having the power monitoring unit and the trigger generating unit. The equipment management system may include an equipment monitoring system having the equipment database, the equipment identifying unit, and the diagnosis information acquiring unit. The display control unit may log in to the energy management system and the equipment monitoring system respectively. The display control unit may provide an integrated user interface for the energy management system and the equipment monitoring system.

(Item 29) The equipment management system may further include a maintenance plan generating unit to generate a maintenance plan regarding at least one of inspection, repair, and replacement of the object equipment, based on diagnosis information that is acquired from each of the plurality of pieces of equipment.

(Item 30) The equipment management system may further include maintenance database to store maintenance history regarding at least one of inspection, repair, and replacement of each of the plurality of pieces of equipment.

(Item 31) The maintenance plan generating unit may determine a priority of maintenance of the plurality of pieces of equipment, based on the power state collected by the power monitoring unit and the diagnosis information collected by the diagnosis information acquiring unit.

(Item 32) The equipment management system may include a maintenance system having the maintenance plan generating unit and the maintenance database. The display control unit may further log in to the maintenance system. The display control unit may provide an integrated user interface for the energy management system, the equipment monitoring system, and the maintenance system.

(Item 33) The equipment management system may further include a power state comparing unit to compare, in an area which one piece of equipment belongs to, power states before and after the repair or replacement of the one piece of equipment.

(Item 34) The equipment management system may further include a synchronization processing unit to synchronize the association relationship of the plurality of areas and the plurality of pieces of equipment, between database for monitoring power regarding the plurality of pieces of equipment included in the energy management system and the equipment database included in the equipment monitoring system.

(Item 35) The equipment identifying unit may select the object equipment out of at least one piece of equipment belonging to the object area, based on setting information that presets which piece of equipment is object equipment in each of the plurality of areas according to the trigger.

(Item 36) The equipment identifying unit may select the object equipment, based on diagnosis information that is acquired from each of at least one piece of equipment belonging to the object area.

(Item 37) The sixth aspect of the present invention may provide an equipment management system. The equipment management system may include an acquiring unit to acquire, from the energy management system, a trigger of equipment monitoring that is generated according to a monitoring result of the power state in each of the plurality of areas. The equipment management system may include an equipment identifying instruction unit to make an equipment monitoring system having equipment database that holds association indicating which piece of the plurality of pieces of equipment belongs to which area of the plurality of areas identify, as object equipment, according to the trigger, at least one piece of equipment belonging to an object area that has caused the trigger, out of the plurality of areas. The equipment management system may include a diagnosis information acquiring unit to acquire, from the equipment monitoring system, diagnosis information of the object equipment that is identified.

(Item 38) The seventh aspect of the present invention may provide an equipment management system. The equipment management system may include an acquiring unit to acquire a trigger of equipment monitoring that is generated according to the monitoring result of the power state in each of the plurality of areas. The equipment management system may include an equipment identifying unit to identify, as object equipment, according to the trigger, at least one piece of equipment belonging to an object area that has caused the trigger, out of the plurality of areas, using the equipment database that holds the association indicating which piece of the plurality of pieces of equipment belongs to which area of the plurality of areas.

The equipment management system may include a diagnosis information acquiring unit to acquire diagnosis information of the object equipment that is identified.

(Item 39) The eighth aspect of the present invention may provide a computer readable medium to store programs. The program may make the computer function as a power monitoring unit to monitor the power state in each of the plurality of areas. The program may make the computer function as equipment database to hold the association indicating which piece of the plurality of pieces of equipment belongs to which area of the plurality of areas. The program may make the computer function as a trigger generating unit to generate a trigger of equipment monitoring, according to the monitoring result of the power state in each of the plurality of areas. The program may make the computer function as an equipment identifying unit, according to the trigger, to identify as object equipment, using the equipment database, at least one piece of equipment belonging to an object area that has caused the trigger, out of the plurality of areas. The program may make the computer function as a diagnosis information acquiring unit to acquire diagnosis information of the object equipment that is identified.

(Item 40) The ninth aspect of the present invention may provide an equipment management method. The equipment management method may include holding, in the equipment database, the association indicating which piece of the plurality of pieces of equipment belongs to which area of the plurality of areas. The equipment management method may include monitoring a power state in each of the plurality of areas. The equipment management method may include generating a trigger of equipment monitoring, according to the monitoring result of the power state in each of the plurality of areas. The equipment management method may include identifying as object equipment, according to the trigger, using the equipment database, at least one piece of equipment belonging to an object area that has caused the trigger, out of the plurality of areas. The equipment management method may include acquiring diagnosis information of the object equipment that is identified.

The summary clause does not necessarily describe all necessary features of the embodiments of the present invention. The present invention may also be a sub-combination of the features described above.

### BRIEF DESCRIPTION OF THE DRAWINGS

FIG. 1 illustrates an equipment management system according to the present embodiment.

FIG. 2 is a workflow illustrating operations of the equipment management system according to the present embodiment.

FIG. 3 illustrates an integrated user interface.

FIG. 4 shows a display in operation of an operating state button.

FIG. 5 is an equipment tree diagram.

FIG. 6 shows a display in operation of a trend button.

FIG. 7 shows another display in operation of the trend button.

FIG. 8 shows a display in operation of an alarm button.

FIG. 9 shows a display of diagnosis information of object equipment.

FIG. 10 shows a display of detailed diagnosis information of the object equipment.

FIG. 11 shows a pop-up window of an alert display.

FIG. 12 illustrates equipment management system according to the present embodiment.

FIG. 13 is a workflow illustrating operations of the equipment management system according to the present embodiment.

FIG. 14 is a workflow illustrating operations of information display processing of a maintenance object device.

FIG. 15 is a workflow illustrating operations of information display processing of a monitoring object device.

FIG. 16 is a workflow illustrating operations of interruption processing.

FIG. 17 illustrates an exemplary equipment database.

FIG. 18 shows a display of maintenance management information that is displayed in association with a trigger.

FIG. 19 illustrates an exemplary configuration of the computer according to the present embodiment.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

### First Embodiment

### [1. Configuration of Equipment Management System]

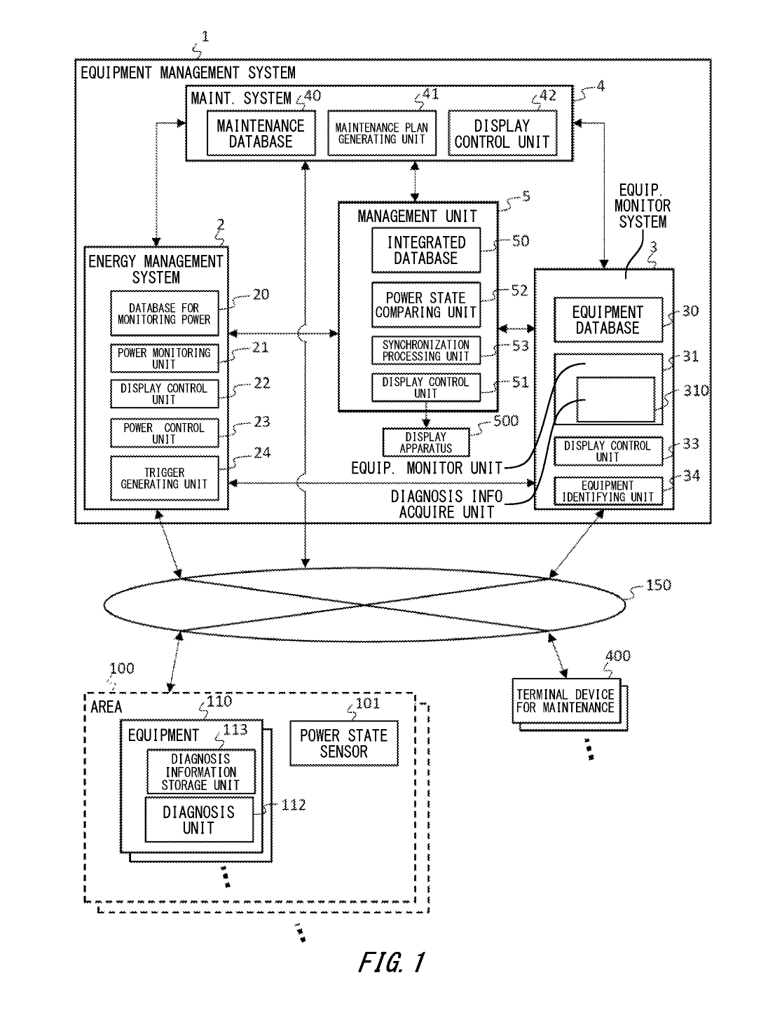

FIG. 1 illustrates an equipment management system 1 according to the present embodiment. The equipment management system 1 comprehensively manages a plurality of pieces of equipment 110 that are located in a plurality of areas 100, and includes an energy management system 2, an equipment monitoring system 3, a maintenance system 4, and a management unit 5.

[1-1. Area]

The area 100 includes at least one piece of equipment 110. For example, the area 100 may be an energy management unit (EMU) including one or more pieces of equipment 110 that can monitor consumption or supply of energy. As an example, the areas 100 may be plants, data centers, retail stores, distribution centers, buildings, condominiums, facilities, production lines etc., or may be further detailed portions thereof (e.g. buildings in plants, floors of the buildings, rooms, a single piece of equipment 110, etc.). Each area 100 may have a power state sensor 101.

The power state sensor 101 measures a power state of the area 100 and transmit it, via an energy management system 2, to a network 150 (the Internet or a dedicated line, as an example). For example, the power state sensor 101 may be a smart meter. The power state may be at least one of power consumption, generated power, a current value, and a voltage value. Note that, instead of the power state sensor 101 transmitting the measurement values directly to the energy management system 2, a collecting apparatus that is not shown may collect the measurement values from the power state sensors 101 of the plurality of areas 100 to transmit them to the energy management system 2. Also, the power state sensors 101 may be provided in the pieces of equipment 110, respectively. As an example, the power state sensors 101 may be provided in each piece of equipment 110 as the area 100, or may be provided in each piece of equipment 110 that is included in the area 100.

[1-2. Equipment]

The equipment 110 is a tool, a machine or an apparatus driven by electric power. The equipment 110 may be a monitoring unit by the equipment monitoring system 3.

For example the equipment 110 may be at least one of the following: a machining center, a transformer, a rotating machine, a servo press machine, an inspection apparatus, a welding machine, a compressor, water receiving and draining equipment, an air conditioner, a generator, a battery, a freezer, a sensor, a server, a showcase, a transport device, and other machines etc. Further, at least one of a server, a controller, a network and a peripheral device etc. that are included in a control system for such equipment 110 may be another piece of equipment 110. Here, the machining center has an automatic tool changer function and is a machining tool to perform, all by itself, various types of machining such as milling, boring, drilling, tapping etc. according to purposes, and may have at least one rotating machine. The generator may be a private power generator by such as the gas engine, the cogeneration system, etc. For its sensors, gas and water flow sensors, power sensors etc. are used. The sensor may be a smart sensor to wirelessly communicate digital measurement values.

These pieces of equipment 110 may be installed according to the types of the areas 100. For example, if the area 100 is a plant, the equipment 110 may be one or more among the following: a machining center, a transformer, a rotating machine, a servo press machine, an inspection apparatus, a welding machine, a compressor, water receiving and draining equipment, an air conditioner, a generator, a battery, a power sensor and a flow sensor etc.; and they may configure an assembly production line. If the area 100 is a data center, the equipment 110 may be one or more among a battery, a power sensor, a server, and an air conditioner etc. If the area 100 is a retail store, the equipment 110 may be one or more among a showcase, a freezer, a power sensor, a flow sensor, and an air conditioner etc.

Pieces of equipment 110 may each have diagnosis units 112 and diagnosis information storage units 113, respectively.

The diagnosis unit 112 diagnoses the equipment 110 and supplies diagnosis information indicating the result to the diagnosis information storage unit 113. For example, the diagnosis unit 112 may measure an operating state of the equipment 110 by a sensor (not shown) to perform a diagnosis. The operating state may be different from the power state. The diagnosis unit 112 may perform data analyses per millisecond to diagnose whether abnormalities due to failures exist or not, or it may perform data analyses per every several months to diagnose whether abnormalities due to deterioration exist or not. The diagnosis information may include whether the equipment 110 is in normal state or not, measurement values and measurement time by the sensors, and operating conditions of the equipment 110 at the measurement time.

For example, if the equipment 110 is a rotating machine or the like, the diagnosis unit 112 may measure, as the operating state, a vibration state to perform a diagnosis. As an example, the diagnosis unit 112 may perform a diagnosis by the absolute evaluation method or the relative evaluation method, performing a FFT analysis of the high frequency or the low frequency on the measurement result, using the sensors of acceleration, velocity, or displacement.

Also, if the equipment 110 is a battery, the diagnosis unit 112 may measure, as the operating state, its temperature, internal resistance and/or voltage etc. to perform a diagnosis. As an example, using the temperature sensor, internal resistance sensor, and/or voltage sensor, the diagnosis unit 112 may perform a diagnosis by comparing the measurement values and the reference thresholds.

Also, if the equipment 110 is a server, a controller, a network and a peripheral device etc. of a control system, the diagnosis unit 112 may acquire the operating states shown in Table. 1 below to perform a diagnosis.

TABLE 1

| Type of Equipment | Operating State |
|---|---|
| Server | Accumulated operation time/Power interruption |
| | time of Control system |
| | System log, Server log |
| | Usage rate (CPU, memory, disk), Process status |
| | Number of executed jobs, Number of error jobs |
| Controller | Configuration information (configuration, |
| | quantity, version number, serial number) |
| | Accumulated operation time/Power interruption |
| | time of Control system |
| | Severe/Minor failure information |
| Network | System counter, Network counter |
| | Registered memory region data |
| Peripheral Device | Operation time, Relay ON/OFF count |
| | Operation delay time, Number of communication |
| | errors |

Note that, the diagnosis unit 112 may measure temperature and humidity, carbon dioxide concentration, illuminance, wind direction and wind speed, rainfall, etc. to be used for performing a diagnosis.

The diagnosis information storage unit 113 holds diagnosis information that is supplied from the diagnosis unit 112. The diagnosis information storage unit 113 can communicate with the equipment monitoring system 3 via the network 150 (the Internet or a dedicated line, as an example).

Note that the diagnosis unit 112 and the diagnosis information storage unit 113 may not be provided in the equipment 110, but may be included in the equipment monitoring system 3. In this case, a sensor to monitor the operating state is provided in the equipment 110, and the diagnosis unit 112 may perform a diagnosis based on measurement values transmitted from this sensor to make the resultant stored in the diagnosis information storage unit 113.

[1-3. Energy Management System]

The energy management system 2 is for controlling power regarding an area 100 of a client of the energy management system 2, and may be a cloud server, as an example. The client of the energy management system 2 is also a client of the equipment management system 1, as an example in the present embodiment. The energy management system 2 has database for monitoring power 20, a power monitoring unit 21, a display control unit 22, a power control unit 23, and a trigger generating unit 24.

The database for monitoring power 20 accumulates and stores the measurement value transmitted from the power state sensor 101, in association with identification information of the client and the identification information of the area 100. Note that, between the database for monitoring power 20 and both equipment database 30 and maintenance database 40 described below, identification information of the same object (the client, the area 100 and the equipment 110 etc., as an example) may be different. The association of the identification information may be stored in an integrated database 50 in a management unit 5 described below.

The power monitoring unit 21 monitors respective power states of the plurality of areas 100 and detects whether abnormalities exist or not. The power monitoring unit 21 may detect whether abnormalities exist or not using the measurement values received from the power state sensor 101, and store the resultant in the database for monitoring power 20, in association with the measurement values. Also, the power monitoring unit 21 may supply, to the power control unit 23, whether abnormalities exist or not, and, if abnormalities are detected, it may supply detail of the abnormalities to the trigger generating unit 24.

The display control unit 22 outputs the monitoring result by the power monitoring unit 21 to a display apparatus (not shown). The display control unit 22 may output the monitoring result by the power monitoring unit 21 with a graph of the power state.

Also, if abnormalities are detected by the power monitoring unit 21, the display control unit 22 may output the detail. Thereby, before the failure of the equipment 110, the client can know abnormal states to change the power states.

The power control unit 23 controls power supply based on monitoring results by the power monitoring unit 21 to save the energy. For example, the power control unit 23 may calculate the energy performance indicator (EnPI) for each area 100, and control the power supply by comparing the calculated resultant with a preset energy baseline (EnB). Also, the power control unit 23 may constantly monitor a receiving power to perform a demand control so that the receiving power does not exceed a reference value. As an example, if the receiving power of the area 100 is predicted to exceed the reference value, the power control unit 23 may warn the client, encourage the client to change the operating schedule, or decrease the output of at least a part of the pieces of equipment 110 in the area 100, or turn off its power source. Alternatively, the power control unit 23 may refer to variation patterns of the receiving power within a reference period (e.g. one day, one week, etc.) that are derived from the monitoring result of the receiving power to output a warning to the client on the display control unit 22 at the timing when the receiving power is predicted to exceed the reference value. Also, the power control unit 23 may calculate power demand prediction, power supply-demand balance at each area 100 to make the resultant output to the display control unit 22. The reference value of the receiving power may be a contracted power between the client and its electric power company. If the supplied power to clients is limited, such as in summer, according to the Electricity Business Act, its upper limit value may be the reference value.

The trigger generating unit 24 generates a trigger of equipment monitoring, according to the monitoring result of the power state in each of the plurality of areas 100 to transmit the trigger to the equipment monitoring system 3.

Note that, as long as including the power monitoring unit 21 and the trigger generating unit 24, the energy management system 2 may not include the other configurations.

[1-4. Equipment Monitoring System]

The equipment monitoring system 3 is for monitoring the equipment 110 of the client of the equipment monitoring system 3 to prevent failures, and may be a cloud server, as an example. The client of the equipment monitoring system 3 is also a client of the equipment management system 1, as an example of the present embodiment. The equipment monitoring system 3 has equipment database 30, an equipment monitoring unit 31, a display control unit 33 and an equipment identifying unit 34.

The equipment database 30 holds an association indicating which piece of the plurality of pieces of equipment 110 belongs to which area of the plurality of areas 100. For example, the equipment database 30 may hold the identification information of the client, the identification information of each area 100, and the identification information of the equipment 110 belonging to the area 100, associated with each other. Additionally, the equipment database 30 may accumulate and store the diagnosis information that is acquired from the diagnosis information storage unit 113 of the equipment 110 in each of the pieces of equipment 110.

The equipment monitoring unit 31 is for monitoring respective operating states of the plurality of pieces of equipment 110, and includes a diagnosis information acquiring unit 310. The diagnosis information acquiring unit 310 acquires the diagnosis information from the diagnosis information storage unit 113 that is held by each of the plurality of pieces of equipment 110 to be stored in the equipment database 30.

The display control unit 33 outputs a regular periodic report of the diagnosis information of each piece of equipment 110 to a display apparatus (not shown). Thereby, the client can know the state, remaining life etc. of the equipment 110. In addition, by diagnosis information of the equipment 110 such as a server, a controller, a network and a peripheral device included in the control system, the client can know lack of resources of the equipment 110 that is a control object by the control system, and also predict intermittent failures due to unknown causes. The display control unit 33 may output measurement values, operating conditions etc. included in the diagnosis information in the form of graph.

Also, if the diagnosis information indicates that abnormalities exist in the equipment 110, the display control unit 33 may output contents of the diagnosis information. Thereby, the client can know the abnormal state before failures of the equipment 110 to perform maintenance of the equipment 110 or stop the operation, etc., and thus the equipment 110 can be stably operated. The display control unit 33 may output the history of the diagnosis information indicating the abnormalities.

In response to receiving a trigger of equipment monitoring from the trigger generating unit 24, the equipment identifying unit 34 identifies, using the equipment database 30, as object equipment to monitor by the equipment monitoring system 3, at least one piece of equipment belonging to an object area that has caused the trigger, out of the plurality of areas 100. Here, the object area that has caused the trigger is an area where abnormalities are detected in the power state. The equipment identifying unit 34 may supply, to the diagnosis information acquiring unit 310, the identification information of the object equipment that is identified, and encourage the diagnosis information acquiring unit 310 to acquire the diagnosis information of the object equipment.

Note that, as long as including the equipment database 30 and the equipment identifying unit 34, the equipment monitoring system 3 may not include the other configurations.

[1-5. Maintenance System]

The maintenance system 4 is for holding a maintenance history of the equipment 110 of the client of the maintenance system 4 and providing its maintenance plan, and may be a cloud server, as an example. The maintenance plan may be a schedule of inspection, repair, and replacement of the equipment 110 and its parts, for example. The client of the maintenance system 4 is also a client of the equipment management system 1, as an example in the present embodiment. The maintenance system 4 has maintenance database 40, a maintenance plan generating unit 41, and a display control unit 42.

The maintenance database 40 stores a maintenance history regarding at least one of inspection, repair, and replacement of each of the plurality of pieces of equipment 110. For example, the maintenance database 40 may stores an equipment ledger where the followings are associated each other: the identification information of the client, identification information of each piece of equipment 110, identification information of the area 100 in which the equipment 110 is installed, identification information of the parts included in the equipment 110, a history of inspection, repair, and replacement of the equipment 110 and its parts in the past, the number of spare parts in stock, etc. The maintenance database 40 may store information of inspection, repair, and replacement that are transmitted, via the network 150 (the Internet or a dedicated line, as an example), from the terminal device for maintenance 400 carried by workers for the maintenance system 4. The terminal device for maintenance 400 may be a wearable device such as in the form of the pair of glasses, for example.

The maintenance database 40 may store maintenance plans that are generated by the maintenance plan generating unit 41 on each piece of equipment 110.

The maintenance plan generating unit 41 generates a maintenance plan regarding at least one of inspection, repair, and replacement of each piece of equipment 110, using the maintenance histories stored in the maintenance database 40, to be supplied to the display control unit 42 and the maintenance database 40. For example, the maintenance plan generating unit 41 may generate a maintenance plan so that the maintenance plan generating unit 41 diagnoses the degree of deterioration of the equipment 110 based on results of the regular inspections to make inspection, repair, or replacement performed before a timing when failures or performance degradation are predicted.

The maintenance plan generating unit 41 may generate a maintenance plan based on the diagnosis information that is acquired from each of the plurality of pieces of equipment 110 by the diagnosis information acquiring unit 310. For example, the maintenance plan generating unit 41 may diagnose the degree of deterioration of the equipment 110, at timing when a regular report is output by the equipment monitoring system 3, referring to the diagnosis information stored in the equipment database 30 and the inspection result stored in the maintenance database 40, to generate a maintenance plan.

Also, the maintenance plan generating unit 41 may determine the priority of maintenance of the plurality of pieces of equipment 110, based on the power state collected by the power monitoring unit 21 and the diagnosis information collected by the diagnosis information acquiring unit 310. For example, the maintenance plan generating unit 41 may calculate the degree of deterioration of each piece of equipment 110 based on the power state and the diagnosis information of the plurality of pieces of equipment 110, and determine the priority among the plurality of pieces of equipment 110 such that ones that are predicted to have failures or performance degradation at earlier timings gets inspected, repaired, or replaced earlier, whereas ones without abnormalities are put off getting inspected, repaired, or replaced earlier. Alternatively or additionally, the maintenance plan generating unit 41 may calculate the severity or the frequency of the power abnormalities based on the collected power state, and, using the calculated value, determine the priority by weighting the degree of deterioration of each piece of equipment 110 calculated from the diagnosis information etc. The maintenance plan generating unit 41 may read out the power state from the database for monitoring power 20 and the diagnosis information from the equipment database 30, and calculate, by the multivariate analysis, the degree of deterioration, severity of abnormalities etc.

The display control unit 42 outputs a maintenance state of each piece of equipment 110 to a display apparatus (not shown). Thereby, the client can know the maintenance state of the equipment 110. The display control unit 42 may output the maintenance history. Also, the display control unit 42 may output the equipment ledger stored in the maintenance database 40, or the maintenance plan generated by the maintenance plan generating unit 41.

[1-6. Management Unit]

The management unit 5 is for integrated management of the plurality of pieces of equipment 110, and may be a cloud server, as an example. The management unit 5 has an integrated database 50, a display control unit 51, a power state comparing unit 52 and a synchronization processing unit 53.

The integrated database 50 associates the identification information of the client, the areas 100 and the pieces of equipment 110 between the equipment management system 1, and the energy management system 2, equipment monitoring system 3, and maintenance system 4. For example, the integrated database 50 stores the client identification information and password for each of the energy management system 2, the equipment monitoring system 3 and the maintenance system 4, associated with the client identification information and password for the equipment management system 1. Also, the integrated database 50 stores the identification information of the area 100 and the equipment 110 for each of the energy management system 2, the equipment monitoring system 3 and the maintenance system 4, associated with the identification information of the area 100 and the equipment 110 in the equipment management system 1.

The display control unit 51 makes the diagnosis information of the object equipment 110 that is acquired by the diagnosis information acquiring unit 310 output to a display apparatus 510. Additionally, the display control unit 51 may keep a logged-in state on the energy management system 2 and the equipment monitoring system 3, and preferably further the maintenance system 4 respectively, to provide an integrated user interface for these systems.

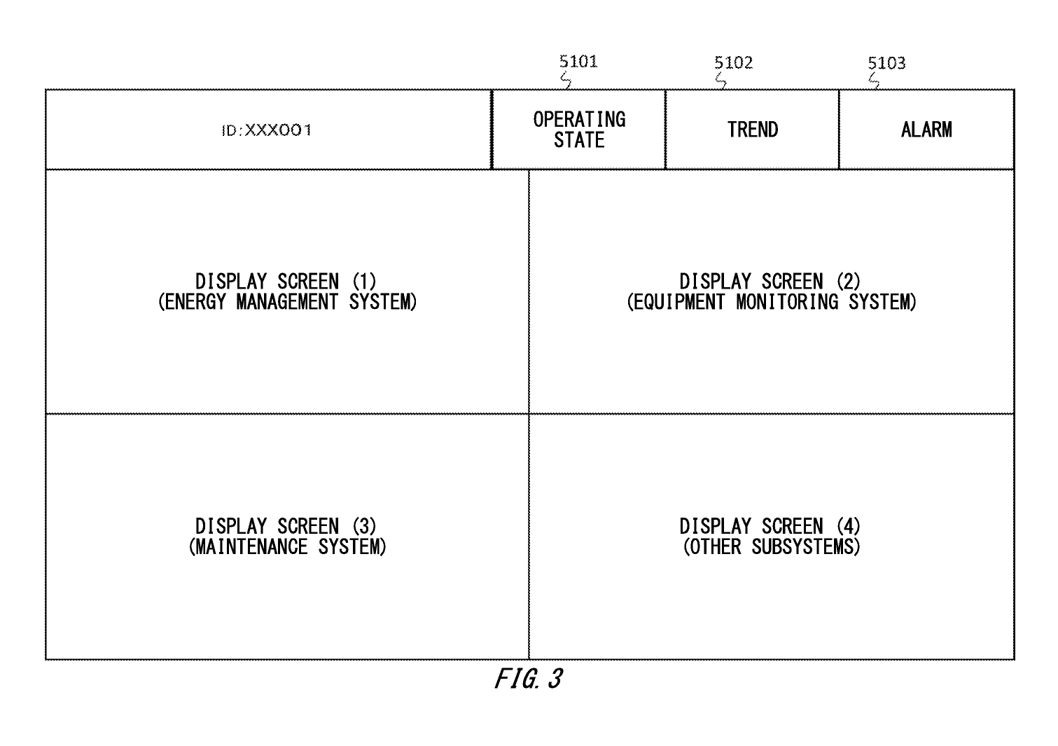

Here, the integrated user interface is an interface to enable communication of information between the client and each of the energy management system 2, the equipment monitoring system 3 and the maintenance system 4, and provides an integrated management environment. For example, the integrated user interface may be a multi-view graphical user interface (GUI) where respective displays of at least the energy management system 2, the equipment monitoring system 3, and the maintenance system 4 are arranged. The detail of display contents of the integrated user interface will be described below, using FIGS. 3 to 11.

The power state comparing unit 52 compares, in an area 100 which one piece of equipment 110 belongs to, power states before and after repair or replacement of the one piece of equipment 110. For example, in the area 100 which includes the repaired or replaced equipment 110, the power state comparing unit 52 may compare, referring to the database for monitoring power 20, the power states at timings before and after the repair and the replacement. The power state comparing unit 52 may provide the comparison result to the display control unit 51. This enables to judge whether the power state has been back to normal state by the repair and the replacement.

The synchronization processing unit 53 synchronizes the association relationship of the plurality of areas 100 and the plurality of pieces of equipment 110 between the database for monitoring power 20 and the equipment database 30, and preferably, in addition, the maintenance database 40. For example, the synchronization processing unit 53 may perform the synchronization if the client logs in to the equipment management system 1. Also, the synchronization processing unit 53 may perform the synchronization in response to operation instructions by the client if the client adds, moves, removes the equipment 110 or the like, or by regularly updating the contents of each database with the latest information.

According to the equipment management system 1 described above, a trigger of equipment monitoring occurs according to the monitoring result of the respective power states of the plurality of areas 100, and the diagnosis information of the at least one piece of equipment 110 belonging to the object area 100 that has caused the trigger is acquired. Accordingly, using the diagnosis information of the equipment 110 in the area 100 having abnormalities in the power state, the equipment 110 having abnormalities can be identified at an early stage to get inspected, repaired, or replaced. Then, if equipment 110 gets operated again and gets abnormalities in the power state, the equipment 110 having abnormalities is again identified at an early stage to get inspected, repaired, or replaced. The equipment 110, in such manner, can be operated in an appropriate state without abnormality, and thus consumption of energy can be saved, so that the consumption amount can be reduced.

Note that, as long as including at least the power monitoring unit 21, the equipment database 30, the trigger generating unit 24, the equipment identifying unit 34, and the diagnosis information acquiring unit 310, the equipment management system 1 may not include the other configurations.

### [2. Operations of Equipment Management System]

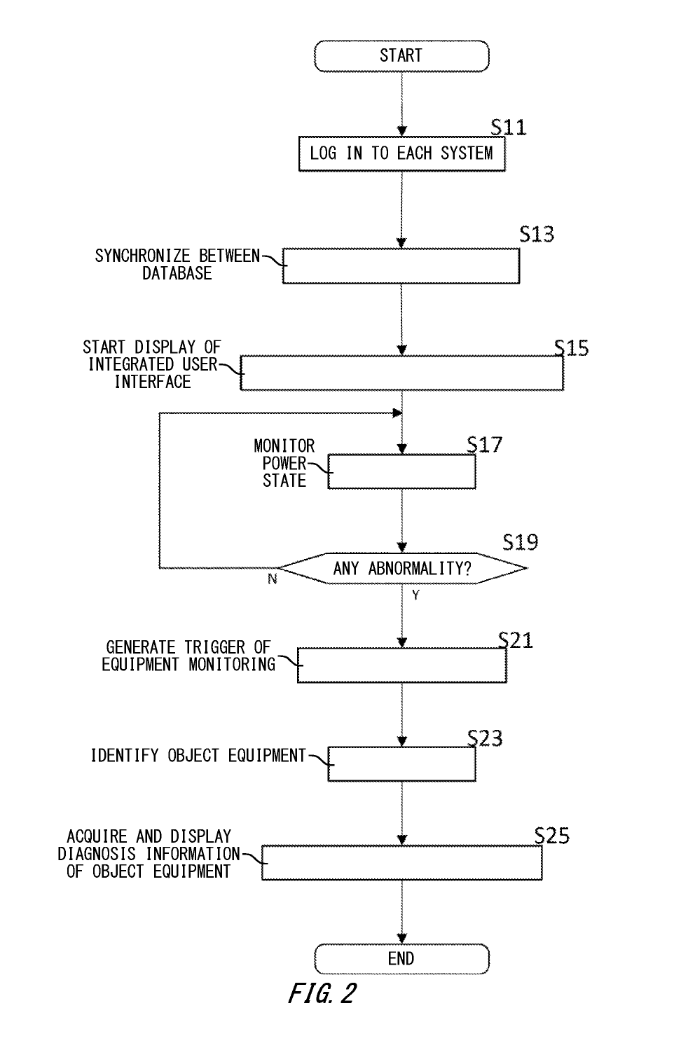

FIG. 2 is a workflow illustrating operations of the equipment management system 1 according to the present embodiment. Note that, in these operations, the association indicating which piece of the plurality of pieces of equipment 110 belongs to which area of the plurality of areas 100 is already held in the equipment database 30.

Firstly, the display control unit 51 logs in the energy management system 2, the equipment monitoring system 3, and the maintenance system 4, respectively (step S11). For example, in response to receiving, from the client, input of the client identification information and password in the equipment management system 1, the display control unit 51 may read out, from the integrated database 50, the client identification information and password in the energy management system 2, the equipment monitoring system 3 and the maintenance system 4 respectively, and may log in the respective systems.

Then, the synchronization processing unit 53 synchronizes the association relationship of the plurality of areas 100 and the plurality of pieces of equipment 110 between the database for monitoring power 20, the equipment database 30, and the maintenance database 40 (step S13).

Then, the display control unit 51 makes display of the integrated user interface on the display apparatus 510 starts (step S15). Thereby, displays of at least the energy management system 2, the equipment monitoring system 3 and the maintenance system 4 are displayed arranged, so that the communication of information between these respective systems and the client is enabled. For example, if one area 100 or equipment 110 is selected by a client in the integrated user interface, the display control unit 51, referring to the integrated database 50, identifies the respective identification information of the energy management system 2, the equipment monitoring system 3 and the maintenance system 4 of the selected area 100 or equipment 110, reads out the information associated with the identification information from the energy management system 2, the equipment monitoring system 3 and the maintenance system 4, to be displayed on the display apparatus 510.

Here, in the display of the energy management system 2, the display control unit 51 may make a display indicating the power supply-demand relationship between the plurality of areas 100 output to the display apparatus 510.

Also, in the display of the equipment monitoring system 3, the display control unit 51 may make the plural types of diagnosis information of one piece of equipment 110 that are acquired by the diagnosis information acquiring unit 310 displayed using a plurality of windows. For example, the display control unit 51 may make diagnosis information of the temperature, the internal resistance, the voltage etc. of a battery as the equipment 110 displayed on different windows.

Then, the power monitoring unit 21 monitors the power state in each of the plurality of areas 100 (step S17). For example, the power monitoring unit 21 may monitor the power state of pieces of equipment 110 belonging to each of the plurality of areas 100. The power monitoring unit 21 may monitor the power state using respective power state sensors 101 for the areas 100. The power monitoring unit 21 may detect abnormalities in response to that power consumption in one area 100 exceeds a preset upper limit value (rated power consumption, as an example). Additionally or alternatively, the power monitoring unit 21 may detect abnormalities in response to that the power consumption goes below a lower limit value.

Here, the power state sensor 101 may transmit the measurement value to the power monitoring unit 21 in any format of text (CSV), mail, and digital input (DI). In the format of text and mail, the measurement values within a measurement period are transmitted being aligned. In this case, the power monitoring unit 21 may analyze the received contents and generate time series data of the measurement values, and, for example if any of the measurement values exceeds its reference threshold or its threshold for a certain period (monitored by a time integrated value, not by an instantaneous value), may detect abnormalities. On the other hand, in the format of the digital input, measurement values at one measurement timing are transmitted. In this case, the power monitoring unit 21 may detect abnormalities, for example if the received measurement values are varied beyond a reference varied width with respect to the previous measurement values, or if variance beyond the reference varied width is continuously detected more than a predetermined times (e.g. three times).

Then, the power monitoring unit 21 judges whether abnormalities exist in the power state (step S19). If no abnormality is judged to exist in the processing of step S19 (S19; No), the power monitoring unit 21 moves to step S17 processing.

If abnormalities are judged to exist in step S19 processing (S19; Yes), the trigger generating unit 24 generates the trigger of equipment monitoring to transmit to the equipment monitoring system 3 (step S21). Thereby, according to the monitoring results of the power state in each of the plurality of areas 100, a trigger of equipment monitoring occurs. For example, if a broken drill or a cut strip caught happens at the equipment 110 that is a rotating machine in the machining center, the trigger of equipment monitoring occurs according to detection of abnormalities in the power state.

Here, the trigger may include identification information of the object area that has caused generation of the trigger (identification information in the energy management system 2, as an example), the occurring time and contents etc. of the abnormalities that have caused generation of the trigger.

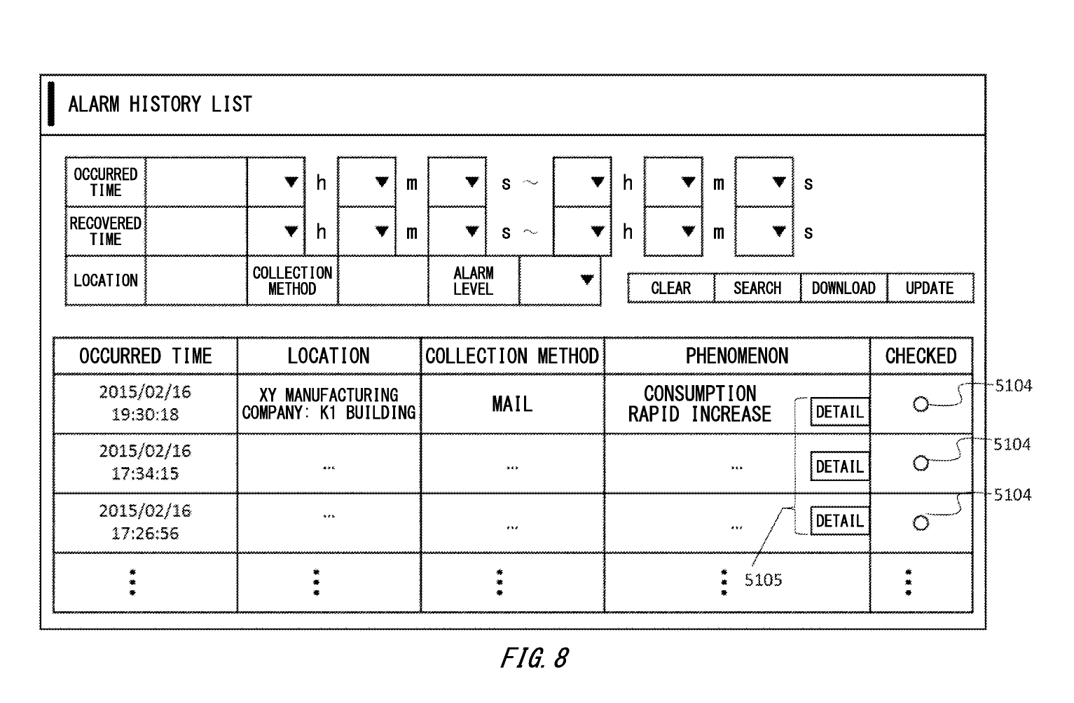

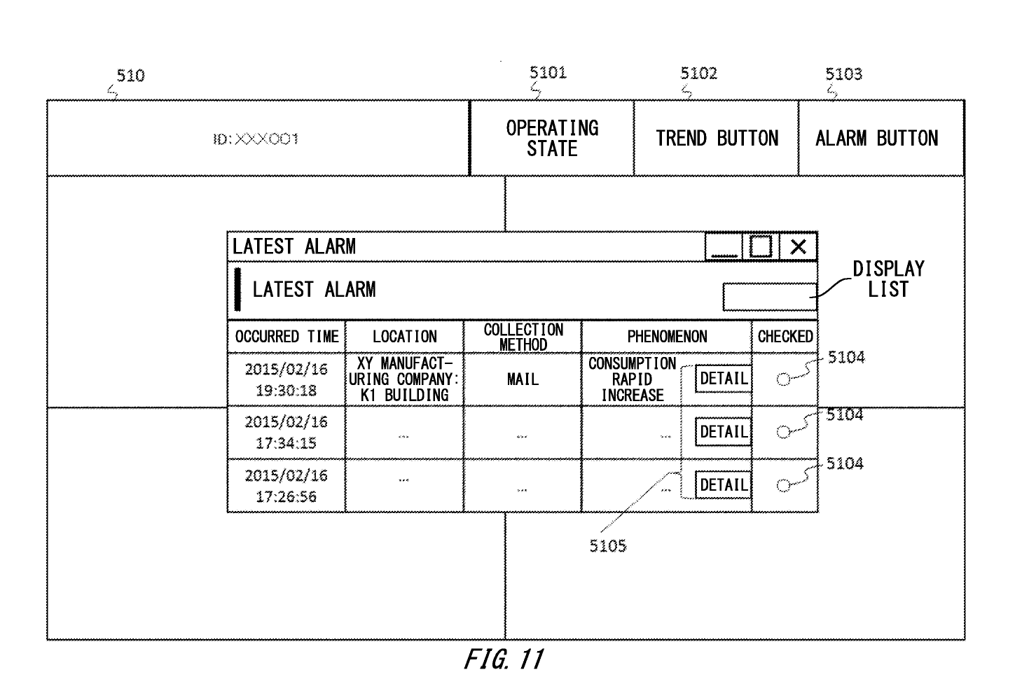

The trigger generating unit 24 may transmit the trigger to the management unit 5. In response to receiving the trigger, the display control unit 51 of the management unit 5 may make an alert display to inform the client of occurrence of the trigger output to the display apparatus 510. The detail of the alert display will be described below, using FIGS. 8, 11.

Then, the equipment identifying unit 34 of the equipment monitoring system 3 identifies as object equipment, using the equipment database 30, at least one piece of equipment 110 belonging to an object area 100 that has caused the trigger, that is, the area 100 where abnormalities in the power state are detected (step S23). For example, the equipment identifying unit 34 may identify, referring to the integrated database 50, the identification information of the object area 100 in the equipment monitoring system 3, and identify, as object equipment, at least one piece of equipment 110 associated with the area 100 indicated by the identification information in the equipment database 30.

The equipment identifying unit 34 may select object equipment based on the diagnosis information that is acquired from each of the pieces of equipment 110 belonging to the object area 100. For example, the equipment identifying unit 34 may identify, referring to the equipment database 30, as object equipment, a piece of equipment 110 whose diagnosis information indicates abnormalities.

Also, the equipment identifying unit 34 may select object equipment based on the maintenance history that is acquired from the maintenance database 40 regarding each of the pieces of equipment 110 belonging to the object area 100. For example, the equipment identifying unit 34 may identify, referring to the maintenance database 40, as the object equipment, at least one piece of equipment 110 that is inspected, repaired, or replaced in the earliest timing.

If identifying at least one piece of object equipment, the equipment identifying unit 34 may refer to the maintenance database 40 and/or the equipment database 30 to add other one or more plurality of pieces of equipment 110 belonging to the same area 100 as the object equipment. For example, the equipment identifying unit 34 may refer to the maintenance database 40 to add, as the object equipment, the equipment 110 which belongs to the same area 100 and equipment 110 for which the same repair is performed as that of the identified object equipment, or for which the same parts are replaced as those of the identified object equipment. Also, the equipment identifying unit 34 may refer to an operating condition of the equipment 110 that is included in the diagnosis information of the equipment database 30 to add, as the object equipment, the equipment 110 that belongs to the same area 100 and is operated at the same operating condition as that of the identified object equipment.

Also, the equipment identifying unit 34 may select object equipment among at least one piece of equipment 110 belonging to the object area 100 based on the setting information stored within the management unit 5. In this setting information, which piece of equipment 110, according to the trigger, is the object equipment is preset regarding each of the plurality of areas 100. For example, if only one piece of equipment 110 that might cause abnormalities exists in the area 100, this equipment 110 may be preset as object equipment.

Then, the diagnosis information acquiring unit 310 acquires the diagnosis information of the object equipment that is identified, and the display control unit 51 outputs the diagnosis information that is acquired on the display apparatus 510 (step S25). The diagnosis information acquiring unit 310 may acquire, from the equipment database 30, the diagnosis information at the occurring time of abnormalities that have caused generation of triggers. Alternatively, the diagnosis information acquiring unit 310 may acquire the latest diagnosis information from the diagnosis information storage unit 113 that is the object equipment. The display control unit 51 may make the diagnosis information of the object equipment output to the display apparatus 510, in response to receiving an instruction from the client to display the detail of the trigger in the alert display displayed on the display apparatus 510.

If plural types of diagnosis information regarding a one piece of equipment 110 is already displayed on a plurality of windows in the display of the equipment monitoring system 3, the display control unit 51, in response to diagnosis information of the object equipment being acquired, may make various types of diagnosis information associated with the object equipment displayed, switching these plurality of windows to display. As an example, the display control unit 51 may switch the display such as the same kind of diagnosis information is displayed on each of the windows before and after switching. Also, after closing the displayed window once, the display control unit 51 may make again the diagnosis information of the object equipment displayed on at least one of the windows.

Note that, in the description above, it is described that the equipment monitoring system 3 acquires the diagnosis information of the object equipment, but the management unit 5 may acquire it. For example, the management unit 5 may include an acquiring unit to acquire the trigger from the trigger generating unit 24, an equipment identifying supporting unit to make the equipment monitoring system 3 identify, according to this trigger, object equipment in the object area 100 and a diagnosis information acquiring unit to acquire, from the equipment monitoring system 3, the diagnosis information of the object equipment that is identified. Alternatively, the management unit 5 may include the acquiring unit to acquire the trigger from the trigger generating unit 24, the equipment identifying unit to identify, according to this trigger, the object equipment in the object area 100 using the equipment database 30, and the diagnosis information acquiring unit to acquire the diagnosis information of the object equipment that is identified.

### [3. Display Example of Integrated User Interface]

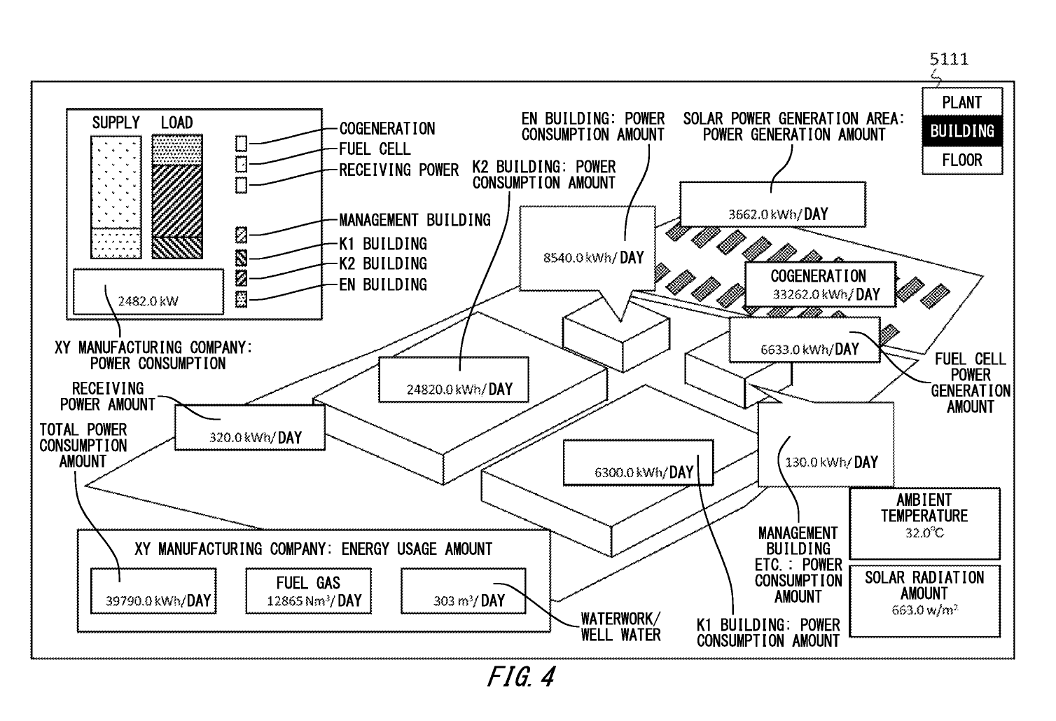

FIG. 3 illustrates an integrated user interface. The integrated user interface may be a graphical user interface (GUI) having the following displays arranged: display (1) of the energy management system 2, display (2) of the equipment monitoring system 3, display (3) of the maintenance system 4, and display (4) of the other subsystems. The integrated user interface may an operating state button 5101 to make displayed display operating states of the area 100 or the equipment 110, a trend button 5102 to make displayed transition of various types of the measurement values of the area 100 or the equipment 110, and an alarm button 5103 to make an alert display displayed. The detail of the display contents when the respective buttons are operated will be described below, using the following FIGS. 4 to 8.

FIG. 4 shows a display in operation of an operating state button 5101. When the operating state button 5101 is operated in the state shown in FIG. 3, the operating state of the area 100 or the equipment 110 may be displayed on the displays of the energy management system 2 and the equipment monitoring system 3 in the integrated user interface.

For example, in the display of the energy management system 2, as shown in FIG. 4, a display indicating the power supply-demand relationship between the plurality of areas 100 may be displayed. For example, in the display shown in FIG. 4, as an example, a power supply-demand relationship between the plurality of areas 100 such as “K1 Building”, “K2 Building”, “EN Building”, “Management Building”, “Solar Power Generation Area”, etc. in the plant of “XY Manufacturing Company” is shown. This display may further display the entire generated power, power self-sufficiency, carbon dioxide emissions, etc. as a whole of the areas 100. Also, this display may display a select button 5111 to select the scale of the area 100 regarded as the object. If the select button 5111 is operated and, for example, the “Plant” is selected as the scale for the area 100, the display content may be updated such as the entire plant is one area 100.

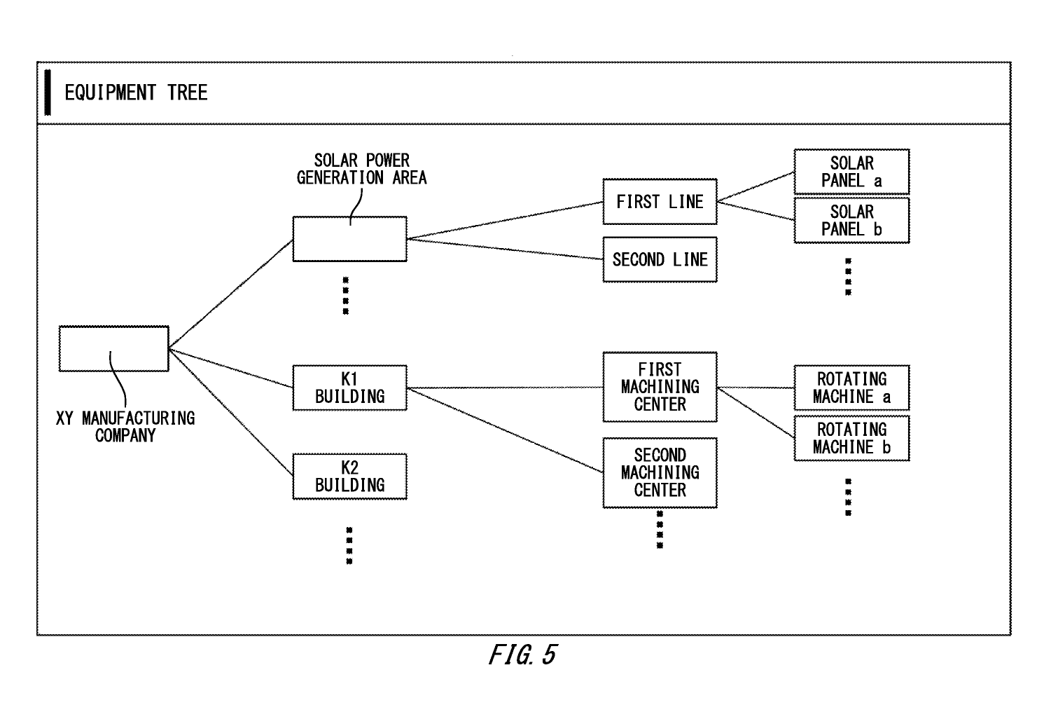

FIG. 5 is an equipment tree diagram. If the operating state is displayed in each display of the energy management system 2 and the equipment monitoring system 3, the display of the maintenance system 4 may display an equipment tree diagram based on the equipment ledger stored in the maintenance database 40. For example, the display shown in FIG. 5 shows that “Solar Power Generation Area” in the plant of “XY Manufacturing Company” has “First Line” and “Second Line”, and the “First Line” includes “Solar Panel a”, “Solar Panel b”, and so on. Also, it shows that “K1 Building” has “First Machining Center” and “Second Machining Center”, and “First Machining Center” includes “Rotating Machine a”, “Rotating Machine b”, and so on.

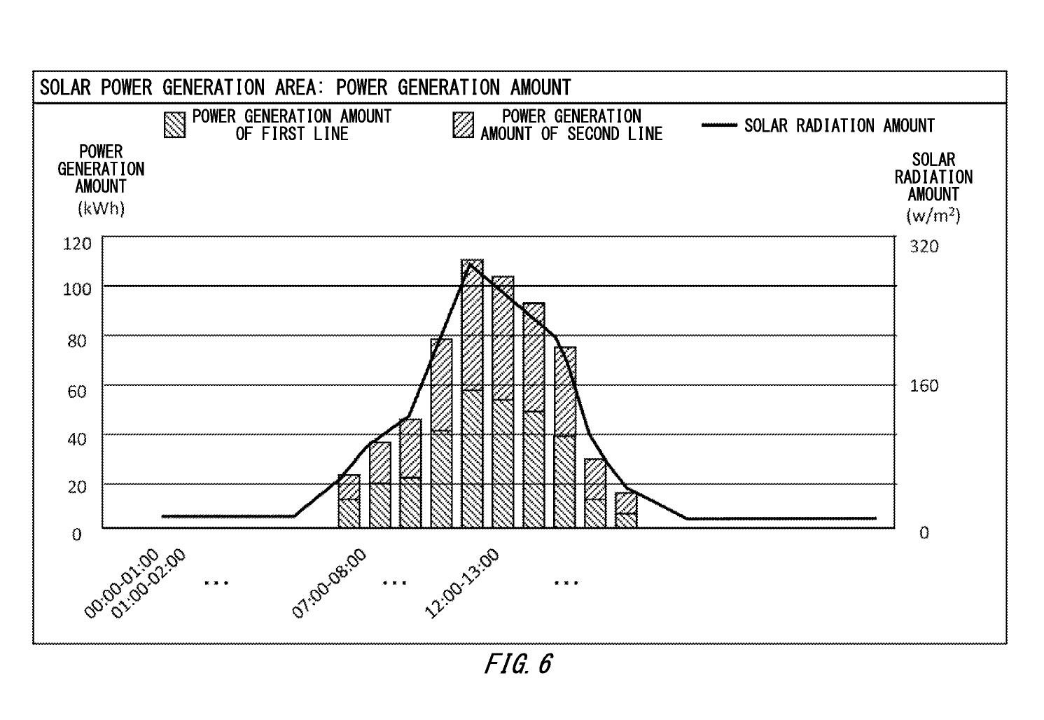

FIG. 6 shows a display in operation of a trend button 5102. When the trend button 5102 is operated in the state shown in FIG. 3, the display of the energy management system 2 in the integrated user interface may display transition of the measurement value of the power state of the area 100 that is measured by the power state sensor 101, and the display of the equipment monitoring system 3 may display transition of the measurement value that is measured by an operating state sensor of the equipment 110. For example, the display shown in FIG. 6 displays, with the graph of the solar radiation amount, transition of the power generation amount of the “First Line” and the “Second Line” in the “Solar Power Generation Area”, the power generation amount being measured for every one hour by the power state sensor 101. Note that, in the figure, the horizontal axis represents time and the vertical axis represents the power generation amount and the solar radiation amount.

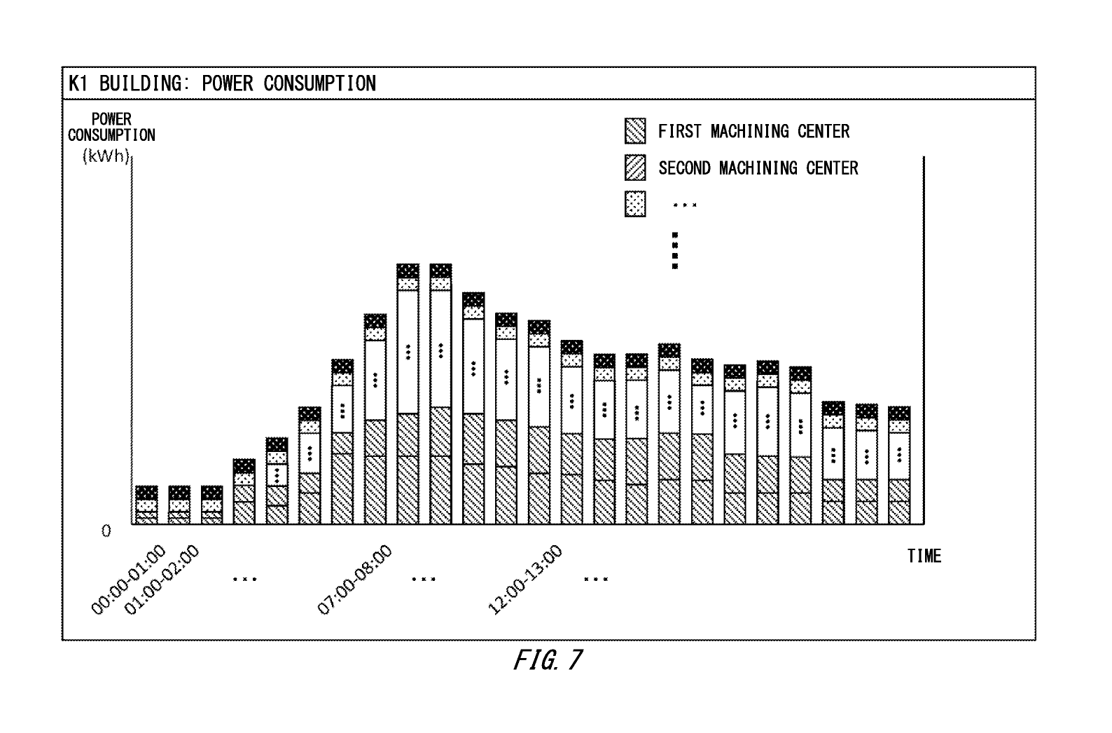

FIG. 7 shows another display in operation of the trend button 5102. For example, the display shown in FIG. 7 displays transition of the power consumption of the “First Machining Center” and the “Second Machining Center”, and so on in the “K1 Building”, the power consumption being measured for every one hour by the power state sensor 101. Note that, in the figure, the horizontal axis represents time and the vertical axis represents the power consumption.

FIG. 8 shows another display in operation of an alarm button 5103. When the alarm button 5103 is operated in the state shown in FIG. 3, the display of the equipment monitoring system 3 in the integrated user interface may display an alert display. The alert display includes a plurality of alert information, which may include, for example, a name of the area 100 that has caused the trigger, occurring time and contents of abnormalities that have caused the trigger etc. FIG. 8 shows, as an example of the alert information, the power consumption of the area 100 that is the “K1 Building” in XY Manufacturing Company, has increased.

The alert display may include a search box to search the alert information. Also, the alert display may displays radio buttons 5104 in association with respective alert information to change the status of the alert information from unchecked to checked, and the alert information with the radio button 5104 not yet operated may be displayed flashing, whereas the alert information with the radio button 5104 already operated may be displayed without flashing.

Additionally, the alert display may display detail display buttons 5105 in association with respective alert information to make the details of the triggers that have caused the alert displayed.

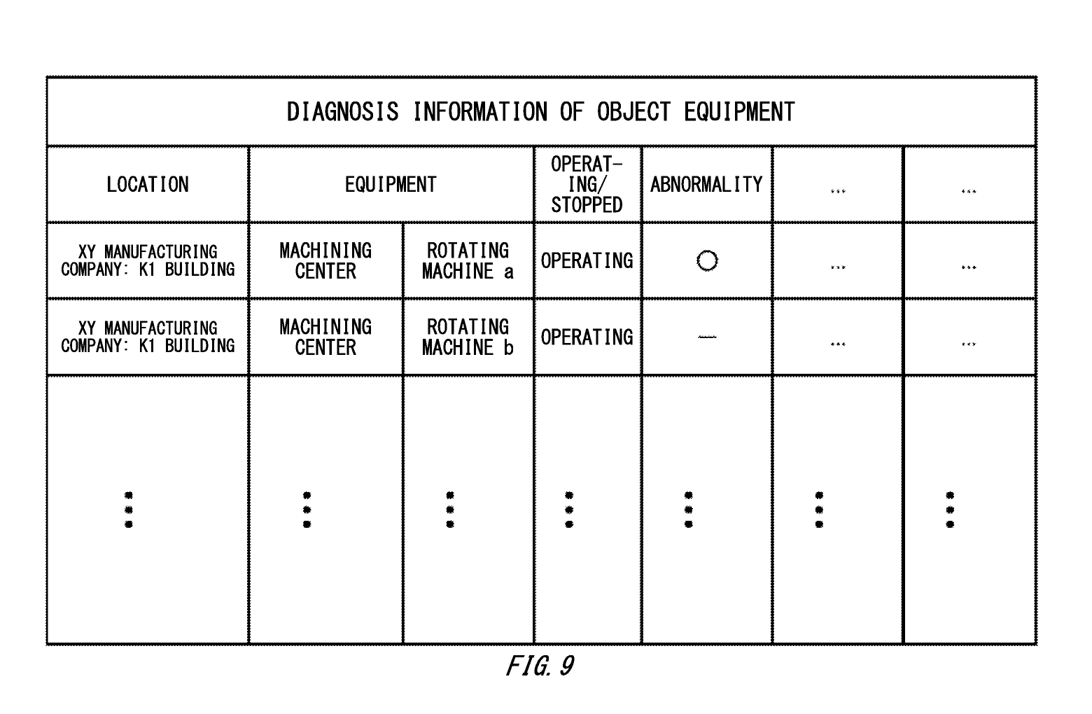

FIG. 9 shows a display of diagnosis information of object equipment. When the detail display buttons 5105 are operated in the state shown in FIGS. 8 and 11 described below, the diagnosis information of at least one piece of the object equipment that is identified by the equipment identifying unit 34 is acquired to be displayed on the display of the equipment monitoring system 3. FIG. 9 shows, as an example of the diagnosis information, the diagnosis information of the equipment 110 such as “Rotating Machine a”, “Rotating Machine b” of “Machining Center” in “K1 Building” in XY Manufacturing Company. This diagnosis information shows that abnormalities have existed in the “Rotating Machine a”.

Note that the displays of the energy management system 2 an the maintenance system 4 may display, as information of the object equipment, the information of the respective systems at the latest timing or at the occurring time of the abnormalities that have caused generation of the trigger.

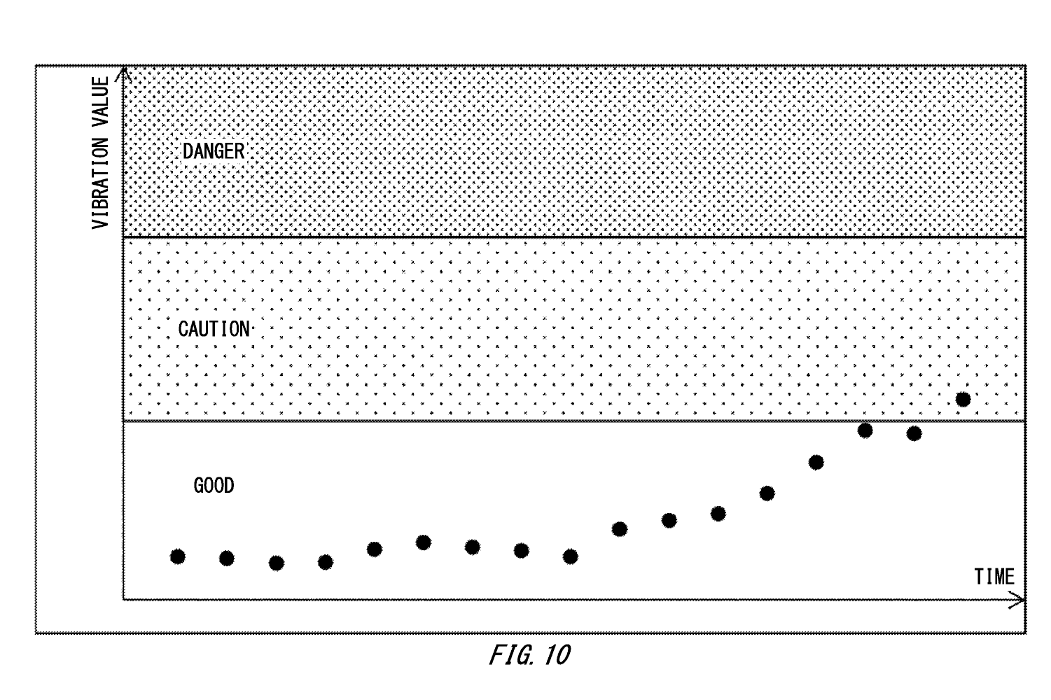

FIG. 10 shows a display of detailed diagnosis information of the object equipment. When any object equipment is selected in the state shown in FIG. 9, detailed diagnosis information of the selected object equipment is displayed. For example, in FIG. 10, in response to the “Rotating Machine a” being selected in the state shown in FIG. 9, a graph of the vibration state is shown as its diagnosis information. This graph indicates that, as an example, the “Rotating Machine a” catches a cut strip, resulting in its vibration value increasing to have exceeded a first threshold, above which informing the client for attention is conducted. In response to the vibration value exceeding the first threshold, the client may inspect the “Rotating Machine a”. Note that, FIG. 10 also illustrates a second threshold, above which informing the client of the “Rotating Machine a” being in dangerous state is conducted. In response to the vibration value exceeding the second threshold, the client may repair or replace the “Rotating Machine a”. In response to the vibration value exceeding the first threshold and/or the second threshold, the power control unit 23 of the energy management system 2 may power off the “Rotating Machine a”, or limit the power control of the area 100 including the “Rotating Machine a”.

FIG. 11 shows a pop-up window of an alert display. In response to the management unit 5 receiving a trigger from the trigger generating unit 24, the integrated user interface may display, as a pop-up window, an alert display to inform the client of occurrence of the trigger. This alert display may display at least one of the alert information whose status is unchecked. By displaying of the alert display, the client can immediately know that abnormalities have occurred in the power state.

### Second Embodiment

### [4. Configuration of Equipment Management System]

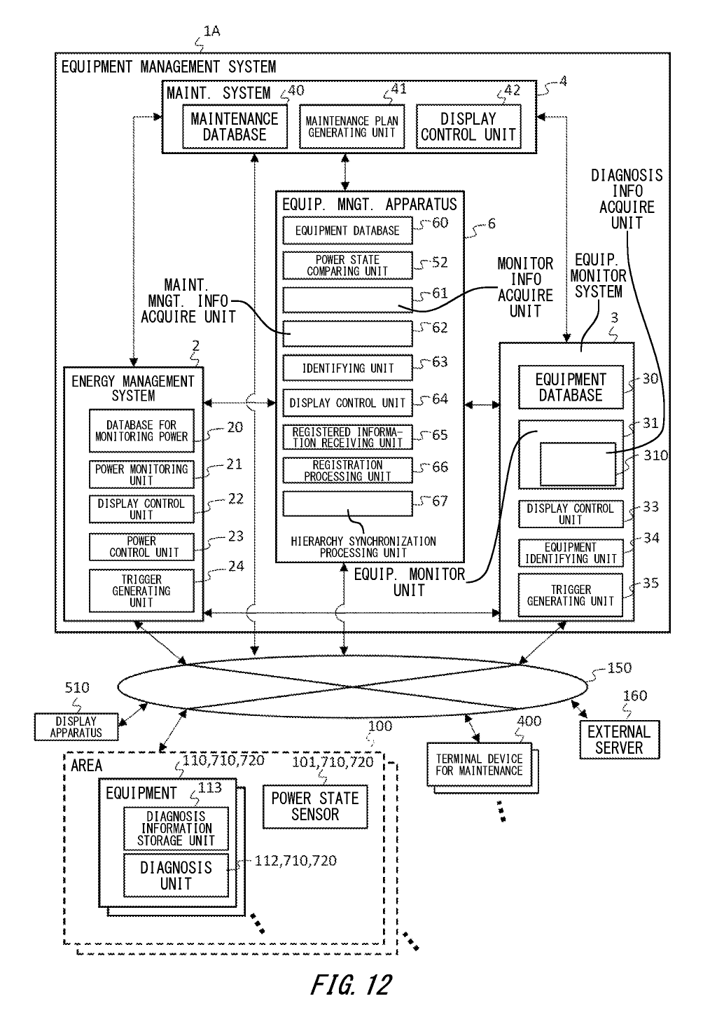

FIG. 12 illustrates an equipment management system 1A according to the present embodiment. In the equipment management system 1A according to the present embodiment, operations approximately the same as those of the equipment management system 1 shown in FIG. 1 are given the same reference numerals and the description will not be repeated.

In the equipment management system 1A according to the present embodiment, the area 100 may be the entire site of the client (tenant) of the energy management system 2 and/or the equipment monitoring system 3. In other words, the energy management system 2 and the equipment monitoring system 3 may be possible to monitor the power state and/or the operating state per client.

The energy management system 2 and the equipment monitoring system 3 are examples of the monitoring apparatus and each monitor a plurality of monitoring object devices 710. The monitoring object device 710 is a monitoring object for at least one of the power state and the operating state, and may be any of, as an example, the equipment 110, the diagnosis unit 112 and the power state sensor 101. The diagnosis unit 112 may measure the rotation speed of the rotating machine as the equipment 110, or measure the pressure in the equipment 110. The power state and the operating state of the monitoring object device 710 may be aggregated with those of other monitoring object devices 710 via repeaters that are not shown, to be supplied to the energy management system 2 and/or the equipment monitoring system 3. The trigger generating unit 24 of the energy management system 2 may generate a trigger, according to the monitoring result of the power state in each of the plurality of areas 100, to be transmitted to the equipment management apparatus 6. The equipment monitoring system 3 may have a trigger generating unit 35 to generate a trigger, according to the monitoring result of the operating state in each of the plurality of areas 100, to be transmitted to the equipment management apparatus 6. The trigger generating unit 35 may generate a trigger if abnormalities exist in the operating state. The trigger may include identification information of the monitoring object device 710 that has caused generation of the trigger, and the occurring time and contents etc. of the abnormalities that have caused generation of the trigger. The database for monitoring power 20 of the energy management system 2 and the equipment database 30 of the equipment monitoring system 3 are examples of the database for monitoring, may each store information of the plurality of monitoring object devices 710, and may be managed by the energy management system 2 or the equipment monitoring system 3.

The maintenance system 4 is an example of the maintenance management apparatus, and performs maintenance management of a plurality of maintenance object devices 720. The maintenance object device 720 is an object for the maintenance management and, as an example, may be any of the equipment 110, the diagnosis unit 112 and the power state sensor 101. The maintenance object device 720 and the monitoring object device 710 may be the same devices, or different devices. The maintenance database 40 of the maintenance system 4 is an example of the maintenance management database, may store information of the plurality of maintenance object devices 720, and may be managed by the maintenance system 4.

Here, without the synchronization processing by the equipment management apparatus 6 described below, the database for monitoring power 20 and the equipment database 30 may store the information of the plurality of monitoring object devices 710 in a first hierarchical structure, and the maintenance database 40 may store the information of the plurality of maintenance object devices 720 in a second hierarchical structure. In the present embodiment, the first hierarchical structure and the second hierarchical structure may be different from each other, and thus, for example, one of the hierarchical structures may include at least one hierarchy that is not associated with any hierarchy included in the other hierarchical structure. As an example, the first hierarchical structure may include, in addition to the monitoring object device 710, at least part of hierarchy such as a client, a plant owned by the client, buildings, floors, and production lines etc. The second hierarchical structure may include, in addition to the maintenance object device 720, at least part of hierarchy such as buildings, floors, and production lines etc.

The equipment management system 1A includes an equipment management apparatus 6 to perform integrated management of the plurality of pieces of equipment 110. The equipment management apparatus 6 has equipment database 60, a monitoring information acquiring unit 61, a maintenance management information acquiring unit 62, an identifying unit 63, and a display control unit 64. The equipment management apparatus 6 may further have a registered information receiving unit 65, a registration processing unit 66, and a hierarchy synchronization processing unit 67.

The equipment database 60 stores an association relationship between the plurality of monitoring object devices 710 and the plurality of maintenance object devices 720. For example, the equipment database 60 stores the identification information of the plurality of monitoring object devices 710 and the identification information of the plurality of maintenance object devices 720 respectively, and may associate entries of the monitoring object devices 710 and entries of the maintenance object devices 720 that are associated with each other. As an example, the equipment database 60 may store the identification information of the monitoring object device 710 and the maintenance object device 720 associated with each other in the same record entry. That monitoring object device 710 and the maintenance object device 720 are associated with each other may mean that the both are the same devices, that either one is included in the other (as an example, the diagnosis unit 112 as the monitoring object device 710 is included in the equipment 110 as the maintenance object device 720), or that either one is provided in the other (as an example, the power state sensor 101 as the monitoring object device 710 is provided in the equipment 110 as the maintenance object device 720). The equipment database 60 may store the same content as that of the integrated database 50 described above.

The monitoring information acquiring unit 61 acquires, from the energy management system 2 and/or the equipment monitoring system 3, monitoring information indicating at least one of the power state and the operating state of the monitoring object device 710. The monitoring information acquiring unit 61 may supply the monitoring information that is acquired to the display control unit 64.

The maintenance management information acquiring unit 62 acquires, from the maintenance system 4, maintenance management information of the maintenance object device 720. The maintenance management information may be information indicating any of the maintenance state, the maintenance history, and the equipment ledger of the maintenance object device 720. The maintenance management information acquiring unit 62 may supply the maintenance management information that is acquired to the display control unit 64.

The identifying unit 63 identify, using the equipment database 60, an association relationship between the first monitoring object device 710 and the first maintenance object device 720 out of the plurality of monitoring object devices 710 and the plurality of maintenance object devices 720. For example, the identifying unit 63 may identify the first maintenance object device 720 associated with the first monitoring object device 710, or may identify the first monitoring object device 710 associated with the first maintenance object device 720. The identifying unit 63 may supply the identified result to the display control unit 64.

The display control unit 64 makes associated monitoring information of the first monitoring object device 710 and maintenance management information of the first maintenance object device 720 to be output to the display apparatus 510. For example, the display control unit 64 may make the monitoring information and the maintenance management information of the first monitoring object device 710 and the first maintenance object device 720 associated with each other output arranged, or switched and output according to a user instruction. Note that the display apparatus 510 in the present embodiment may be connected to the equipment management system 1A via the network 150, and may be a display of a user-owned device.

The display control unit 64 may make configurable screen layout information to specify display contents for each of the plurality of windows. For example, the display control unit 64 may make it configurable to display, for at least one window of the plurality of windows, monitoring information of at least one monitoring object device 710, or maintenance management information of at least one maintenance object device 720. In the present embodiment, as an example, the display control unit 64 may provide a multi-view integrated user interface where respective displays of at least the energy management system 2, the equipment monitoring system 3, and the maintenance system 4 are arranged. The display control unit 64 may make it configurable to display, for at least one window in the integrated user interface, information provided by the external server 160. In this case, the screen layout information may include information indicating web page addresses to acquire from the external server 160. The external server 160 may be connected to the equipment management apparatus 6 via the network 150, for example.

The registered information receiving unit 65 receives, from the energy management system 2 and/or the equipment monitoring system 3, registered information on the monitoring side which includes identification information of at least one monitoring object device 710 that is newly registered as the monitoring object in the energy management system 2 and/or the equipment monitoring system 3. For example, the registered information on the monitoring side may be supplied from the energy management system 2 and/or the equipment monitoring system 3 regularly, or every time when a new monitoring object device 710 is registered to the database for monitoring power 20 and/or the equipment database 30.

The registered information receiving unit 65 may receive, from the maintenance system 4, the registered information on the maintenance side which includes the identification information of at least one maintenance object device 720 that is newly registered to the maintenance system 4 as the maintenance management object. For example, the registered information on the maintenance side may be supplied from the maintenance system 4 regularly, or every time when a new maintenance object device 720 is registered to the maintenance database 40.

The registered information receiving unit 65 may supply the received registered information on the monitoring side and/or the registered information on the maintenance side to the registration processing unit 66.

The registration processing unit 66 registers, to the equipment database 60, a monitoring object device 710 that is newly registered based on the registered information on the monitoring side. The registration processing unit 66 may register, to the equipment database 60, a maintenance object device 720 that is newly registered based on the registered information on the maintenance side.

The hierarchy synchronization processing unit 67 synchronizes the first hierarchical structures of the database for monitoring power 20 and the equipment database 30, and the second hierarchical structure of the maintenance database 40. For example, the hierarchy synchronization processing unit 67 may perform synchronization when the equipment management system 1A is started up. The hierarchy synchronization processing unit 67 may perform synchronization when the energy management system 2, the equipment monitoring system 3 and/or the maintenance system 4 are connected to the equipment management apparatus 6. The hierarchy synchronization processing unit 67 may perform synchronization regularly. Here, synchronizing the first hierarchical structure and the second hierarchical structure may mean maintaining the same configurations to each other. For example, the hierarchy synchronization processing unit 67 may detect hierarchies that are included in only one of the first hierarchical structure and the second hierarchical structure but not included in the other, and add the detected hierarchies to the other hierarchical structure. The hierarchy synchronization processing unit 67 may synchronize hierarchies per tree that is detected by performing matching with the identification information such as the area 100 and/or the equipment 110. The hierarchy synchronization processing unit 67 may add, according to user operations, hierarchies to the first hierarchical structure and/or the second hierarchical structure. The hierarchy synchronization processing unit 67, like the synchronization processing unit 53 described above, may synchronizes the association relationship of the plurality of areas 100 and the plurality of pieces of equipment 110 between the database for monitoring power 20 and the equipment database 30, and preferably, in addition, the maintenance database 40.

According to the equipment management system 1A described above, the association relationship between the first monitoring object device 710 and the first maintenance object device 720 is identified, using the equipment database 60 where the association relationship between the plurality of monitoring object devices 710 and the plurality of maintenance object devices 720 is stored. Accordingly, if information of the devices are managed by different hierarchical structures between the energy management system 2 and/or the equipment monitoring system 3 and the maintenance system 4, the association relationship between the monitoring object device 710 and the maintenance object device 720 can be identified.

Also, the first hierarchical structures of the database for monitoring power 20 and the equipment database 30 and the second hierarchical structure of the maintenance database 40 are synchronized, and thus it can be made easier to associate information of devices managed by the energy management system 2 and/or the equipment monitoring system 3 and information of devices managed by the maintenance system 4.

Also, the registered information on the monitoring side which includes identification information of the monitoring object device 710 that is newly registered as the monitoring object is received from the energy management system 2 and/or the equipment monitoring system 3, and, based on this information, the monitoring object device 710 is registered to the equipment database 60. Also, the registered information on the maintenance side which includes identification information of the maintenance object device 720 that is newly registered as the maintenance management object is received from the maintenance system 4 and, based on this information, the maintenance object device 720 is registered to the equipment database 60. Accordingly, if a monitoring object device 710 and/or a maintenance object device 720 is/are added, the content of the equipment database 60 can be updated automatically.

### [5. Operation of Equipment Management System]

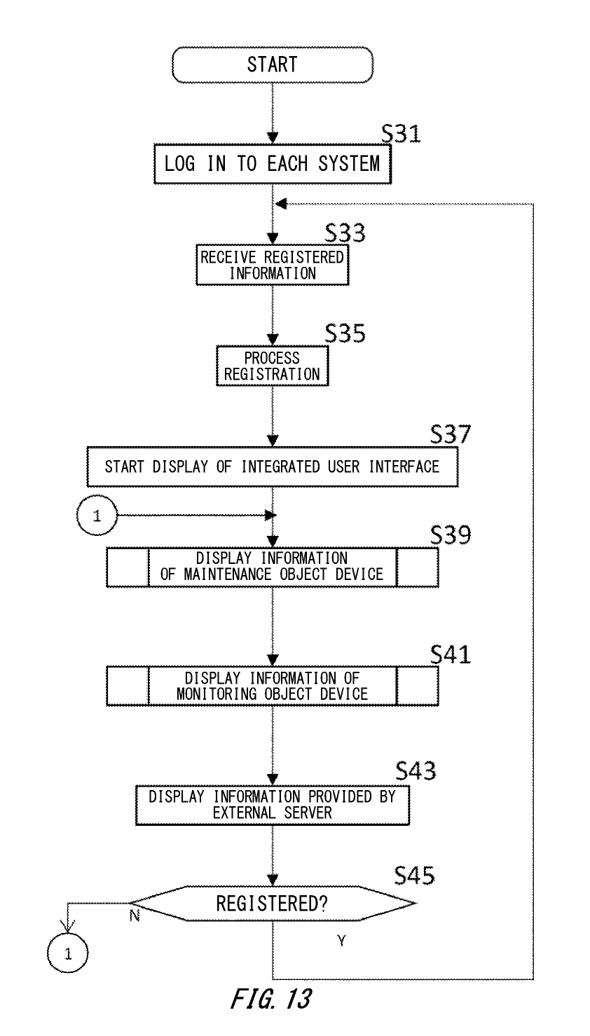

FIG. 13 is a workflow illustrating operations of the equipment management system 1A according to the present embodiment. Note that, in these operations, the first hierarchical structures of the database for monitoring power 20 and the equipment database 30, and the second hierarchical structure of the maintenance database 40 may be already synchronized by the hierarchy synchronization processing unit 67.

Firstly, the display control unit 51, like in step S11 described above, logs in the energy management system 2, the equipment monitoring system 3 and the maintenance system 4, respectively (step S31).

Then, the registered information receiving unit 65 receives, from the energy management system 2 and/or the equipment monitoring system 3, the registered information on the monitoring side which includes identification information of at least one monitoring object device 710 that is newly registered as the monitoring object (step S33). The registered information on the monitoring side may be information indicating a registration state of the monitoring object device 710 in the database for monitoring power 20 and/or the equipment database 30. The registered information on the monitoring side may include storage structures in the database for monitoring power 20 and the equipment database 30, that is, location information of the monitoring object device 710 in the first hierarchical structure (as an example, identification information of a client, a plant, buildings, floors, production lines which the monitoring object device 710 belongs to).

Additionally or alternatively, the registered information receiving unit 65 receives, from the maintenance system 4, the registered information on the maintenance side which includes identification information of at least one maintenance object device 720 that is newly registered as the monitoring object. The registered information on the maintenance side may be information indicating the registration state of the maintenance object device 720 in the maintenance database 40. The registered information on the maintenance side may include storage structures in the maintenance database 40, that is, location information of the maintenance object device 720 in the second hierarchical structure (as an example, identification information of a plant, buildings, floors, production lines which the maintenance object device 720 belongs to).

Then, the registration processing unit 66 registers, to the equipment database 60, a monitoring object device 710 that is newly registered as the monitoring object based on the registered information on the monitoring side (step S35). If at least one maintenance object device 720 associated with the newly registered monitoring object device 710 is already registered to the equipment database 60, the registration processing unit 66 may associate the monitoring object device 710 with the at least one maintenance object device 720 in the equipment database 60. As an example, if the newly registered monitoring object device 710 is the same as an existing maintenance object device 720 in the equipment database 60, the monitoring object device 710 may be registered in association with an entry of the maintenance object device 720. If the newly registered monitoring object device 710 is included, or provided in an existing maintenance object device 720 in the equipment database 60, the monitoring object device 710 may be registered in association with an entry of the maintenance object device 720. The registration processing unit 66 may make the user select at least one maintenance object device 720 among the maintenance object devices 720 that are not associated with any of the plurality of monitoring object devices 710, out of the plurality of maintenance object devices 720. In this case, the monitoring object device 710 may be registered in association with an entry of the selected maintenance object device 720. If the maintenance object device 720 associated with the monitoring object device 710 that is newly registered as the monitoring object is registered to the equipment database 60, the registration processing unit 66 may register the monitoring object device 710 to a new record in the equipment database 60 (as an example, a record including an empty entry to store identification information of the maintenance object device 720).

Additionally or alternatively, the registration processing unit 66 registers, to the equipment database 60, a newly registered maintenance object device 720 as the maintenance management object based on the registered information on the maintenance side. If at least one monitoring object device 710 associated with the newly registered maintenance object device 720 is already registered to the equipment database 60, the registration processing unit 66 may associate the maintenance object device 720 with the at least one monitoring object device 710 in the equipment database 60. As an example, if the newly registered maintenance object device 720 is the same as an existing monitoring object device 710 in the equipment database 60, the maintenance object device 720 may be registered in association with an entry of the monitoring object device 710. If the newly registered maintenance object device 720 is included, or provided in an existing monitoring object device 710 in the equipment database 60, the maintenance object device 720 may be registered in association with an entry of the monitoring object device 710. The registration processing unit 66 may make the user select at least one monitoring object device 710 among the monitoring object device 710 that are not associated with any of the plurality of maintenance object devices 720, out of the plurality of monitoring object devices 710. In this case, the maintenance object device 720 may be registered in association with an entry of the selected monitoring object device 710. If the monitoring object device 710 associated with the maintenance object device 720 that is newly registered as the maintenance management object is registered to the equipment database 60, the registration processing unit 66 may register the maintenance object device 720 to a new record in the equipment database 60 (as an example, a record including an empty entry to store identification information of the monitoring object device 710).

The registration processing unit 66 may make the maintenance system 4 register, to the maintenance database 40, the monitoring object device 710 that is newly registered as the monitoring object to the database for monitoring power 20 and/or the equipment database 30. For example, the registration processing unit 66 may calculate, from location information of the monitoring object device 710 in the first hierarchical structure, location information of the monitoring object device 710 in the second hierarchical structure and, based on this location information, make the monitoring object device 710 registered to the maintenance database 40. Thereby, the new monitoring object device 710 is managed also as the maintenance management object. The registration processing unit 66 may make the energy management system 2 and the equipment monitoring system 3 register, to the database for monitoring power 20 and the equipment database 30, the maintenance object device 720 that is newly registered as the maintenance management object to the maintenance database 40. For example, the registration processing unit 66 may calculate, from location information of the maintenance object device 720 in the second hierarchical structure, location information of the maintenance object device 720 in the first hierarchical structure and, based on this location information, make the maintenance object device 720 registered to the database for monitoring power 20 and the equipment database 30. Thereby, the new maintenance object device 720 is managed also as the monitoring object.

Note that, if the registered information receiving unit 65 does not receive registration information, the steps S33, S35 processing described above may not be performed.

Then, the display control unit 51 makes display of the integrated user interface on the display apparatus 510 starts (step S37). The display control unit 51, like in step S15 described above, may make the user interface displayed. The display control unit 64 may set display contents for each of the plurality of windows, according to user operations. Note that, in the present embodiment, display windows of at least the energy management system 2, the equipment monitoring system 3 and the maintenance system 4 may be displayed overwrapped or displayed arranged. If the display windows are displayed arranged, all the windows may not necessarily display the monitoring information and/or maintenance management information therein and, for example, display may start according to an operation of the user instruction to display.

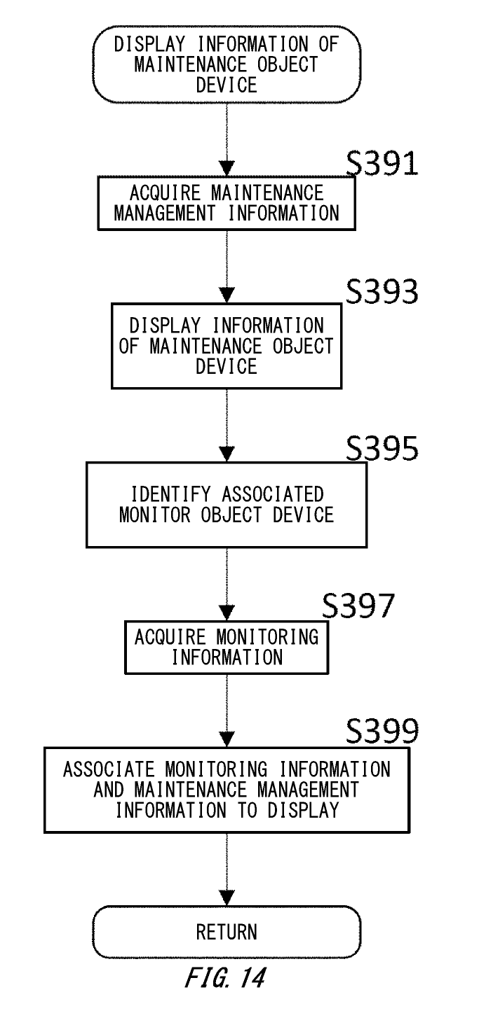

Then, the equipment management apparatus 6 performs information display processing for the maintenance object device 720 (step S39). The detail of this processing will be described below, using FIG. 14. If display of the maintenance management information is not instructed, the equipment management apparatus 6 may not perform step S39 processing.

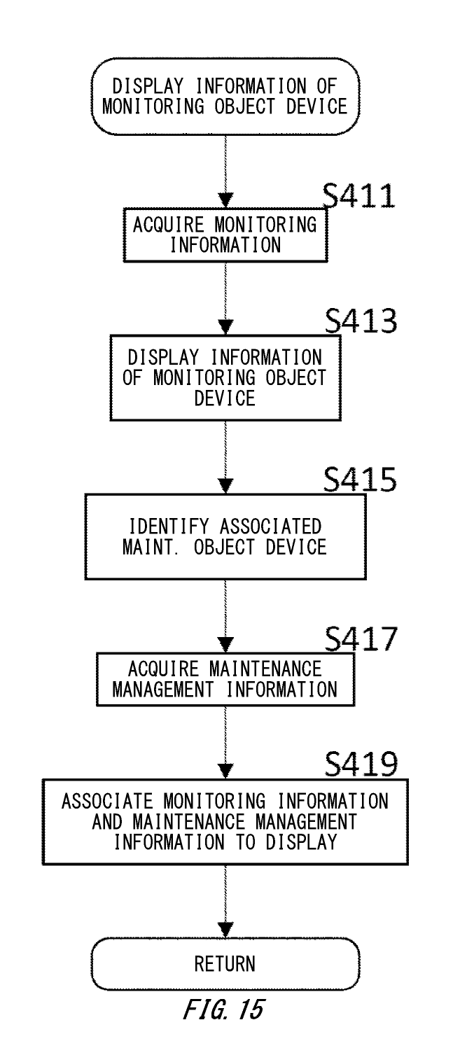

Also, the equipment management apparatus 6 performs information display processing for the monitoring object device 710 (step S41). The detail of this processing will be described below, using FIG. 15. If display of the monitoring information is not instructed, the equipment management apparatus 6 may not perform step S41 processing.

Then, the display control unit 64 makes information provided by the external server 160 on the display apparatus 510 displayed (step S43). For example, the display control unit 64 may acquire a web page from the external server 160 according to address information that is included in the screen layout information to be displayed. The web page to be displayed may be, for example, a page of weather information of an area which the monitoring object device 710 and/or the maintenance object device 720 whose information is displayed belong to, or a page indicating a device specification etc. If display of information from the external server 160 is instructed, the equipment management apparatus 6 may not perform step S43 processing.

Note that steps S39 to S43 processing may be performed in other orders, or in parallel.

Then, the registered information receiving unit 65 judges whether the registered information on the monitoring side and/or the registered information on the maintenance side is/are newly received or not (step S45). If the registered information receiving unit 65 does not receive the registration information (step S45; No), the equipment management apparatus 6 may move to step S39 processing described above. If the registered information receiving unit 65 receives the registration information (step S45; Yes), the equipment management apparatus 6 may move to step S33 processing described above.

According to the operation described above, if the maintenance object device 720 associated with the newly registered monitoring object device 710 is already registered to the equipment database 60, the monitoring object device 710 is associated with the maintenance object device 720 in the equipment database 60; whereas if the monitoring object device 710 associated with the newly registered maintenance object device 720 is already registered to the equipment database 60, the maintenance object device 720 is associated with the monitoring object device 710 in the equipment database 60. Accordingly, if a monitoring object device 710 and/or a maintenance object device 720 is/are added, the association relationship between the monitoring object device 710 and the maintenance object device 720 in the equipment database 60 can be automatically updated.

Also, information such as web pages provided from the external server 160 is displayed, and thus it can be made easier to collate the external information and the monitoring information and/or the maintenance management information.

[5-1. Information Display Processing of Maintenance Object Device]

FIG. 14 is a workflow illustrating operations of information display processing of a maintenance object device 720. If display of the maintenance management information is instructed, the equipment management apparatus 6 performs steps S391 to S399 processing in step S39 described above. Note that, in the operations shown in FIG. 13 described above, by step S39 processing being repeated, steps S391 to S399 processing may be performed in a reference period (in 5 minutes, as an example).

Firstly, the maintenance management information acquiring unit 62 acquires, from the maintenance system 4, maintenance management information of the first maintenance object device 720 out of the plurality of maintenance object devices 720 (step S391). The first maintenance object device 720 may be optionally specified by the user.

Then, the display control unit 64 makes the maintenance management information of the first maintenance object device 720 output to the display apparatus 510 (step S393). The display control unit 64 may make the maintenance management information output to the display window of the maintenance system 4 out of the plurality of windows in the integrated user interface.

Then, the identifying unit 63 identifies, accessing to the equipment database 60, the first monitoring object device 710 that is associated with the first maintenance object device 720, out of the plurality of monitoring object devices 710 (step S395). The identifying unit 63 may perform S395 processing, in response to a user instruction, in the state at step S393, to display the monitoring information of the monitoring object device 710 associated with the first maintenance object device 720. If such user instructions are not given, the equipment management apparatus 6 may not perform processing of step S395 to step S399 described below.

Then, the monitoring information acquiring unit 61 acquires, from the energy management system 2 and the equipment monitoring system 3, the monitoring information of the first monitoring object device 710 that is identified by the identifying unit 63 (step S397). For example, the energy management system 2 and the equipment monitoring system 3 may acquire, from the respective monitoring object devices 710, monitoring information in the format of text (CSV), mail or digital input (DI), etc., and may supply, in response to requests, the monitoring information of the first monitoring object device 710 to the monitoring information acquiring unit 61.

Then, the display control unit 64 finishes the information display processing of the maintenance object device by making the monitoring information of the first monitoring object device 710 displayed on the display apparatus 510, associated with the maintenance management information of the first maintenance object device 720 (step S399). The display control unit 64 may make the monitoring information of the power state and the operating state output to each of the display windows of the energy management system 2 and the equipment monitoring system 3, out of the plurality of windows in the integrated user interface.

According to the information display processing of the maintenance object device 720 described above, when display of the monitoring information of the monitoring object device 710 is instructed by the user in a state where the maintenance management information of the first maintenance object device 720 has been output, the first monitoring object device 710 associated with the first maintenance object device 720 is identified, and its monitoring information is displayed. Accordingly, the maintenance management information and the monitoring information of the associated device can be collated easily.

[5-2. Information Display Processing of Monitoring Object Device]

FIG. 15 is a workflow illustrating operations of information display processing of a monitoring object device 710. If display of the monitoring information is instructed, the equipment management apparatus 6 performs steps S411 to S419 processing in step S41 described above. Note that, in the operation shown in FIG. 13 described above, by step S41 processing being repeated, steps S411 to S419 processing may be performed in a reference period (in 5 minutes, as an example).

Firstly, the monitoring information acquiring unit 61 acquires, from the energy management system 2 and the equipment monitoring system 3, the monitoring information of the first monitoring object device 710 out of the plurality of monitoring object devices 710 (step S411). For example, the energy management system 2 and the equipment monitoring system 3 may acquire monitoring information from the respective monitoring object devices 710 in the format of text (CSV), mail or digital input (DI), etc., and may supply, in response to the request, the monitoring information of the first monitoring object device 710 to the monitoring information acquiring unit 61. The first monitoring object device 710 may be optionally specified by the user.

Then, the display control unit 64 makes the monitoring information of the first monitoring object device 710 output to the display apparatus 510 (step S413). The display control unit 64 may make the monitoring information of the power state and the operating state output to each of the display windows of the energy management system 2 and the equipment monitoring system 3, out of the plurality of windows in the integrated user interface.

Then, the identifying unit 63 identifies, accessing to the equipment database 60, the first maintenance object device 720 that is associated with the first monitoring object device 710, out of the plurality of maintenance object devices 720 (step S415). The identifying unit 63 may perform S415 processing, in response to a user instruction, in the state at step S413, to display the maintenance information of the maintenance object device 720 associated with the first monitoring object device 710. If such instructions are not given by the user, the equipment management apparatus 6 may not perform processing of step S415 to step S419 described below.

Then, the maintenance management information acquiring unit 62 acquires, from the maintenance system 4, maintenance information of the first maintenance object device 720 that is identified by the identifying unit 63 (step S417).

Then, the display control unit 64 finishes the information display processing of the monitoring object device by making the maintenance information of the first maintenance object device 720 displayed on the display apparatus 510, associated with the monitoring information of the first monitoring object device 710 (step S419). The display control unit 64 may make the maintenance information output to the display window of the maintenance system 4 out of the plurality of windows in the integrated user interface.

According to the information display processing of the monitoring object device 710 described above, when display of the maintenance information of the maintenance object device 720 is instructed by the user in a state where the monitoring information of the first monitoring object device 710 has been output, the first maintenance object device 720 associated with the first monitoring object device 710 is identified, and its maintenance information is displayed. Accordingly, the maintenance management information and the monitoring information of the associated device can be collated easily.

[5-3. Interruption Processing]

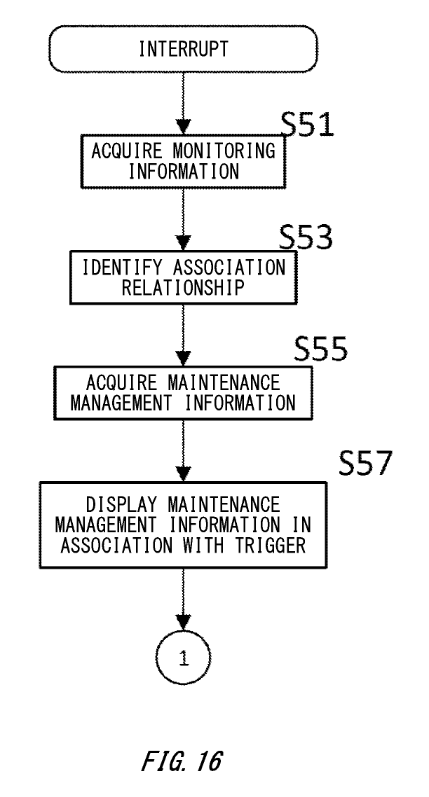

FIG. 16 is a workflow illustrating operations of interruption processing. During the operations shown in FIG. 13, according to the monitoring result of the power state, the equipment management apparatus 6 performs interruption processing of steps S51 to S57 by acquiring a trigger from the trigger generating unit 24. Additionally or alternatively, during the operations shown in FIG. 13, according to the monitoring result of the operating state, the equipment management apparatus 6 performs interruption processing of steps S51 to S57 by acquiring a trigger from the trigger generating unit 35.

Firstly, the monitoring information acquiring unit 61 acquires a trigger from the energy management system 2 and/or the equipment monitoring system 3 (step S51). The trigger may include identification information of the first monitoring object device 710. If a plurality of triggers are generated according to the monitoring result of the plurality of monitoring object devices 710, the monitoring information acquiring unit 61 may acquire the respective triggers. In this case, the respective triggers may each include identification information of different monitoring object devices 710 that have caused the triggers.

Then, the identifying unit 63 identifies, accessing to the equipment database 60, the first maintenance object device 720 that is associated with the first monitoring object device 710, out of the plurality of maintenance object devices 720 (step S53). If a plurality of triggers are acquired in step S51, the identifying unit 63 may identify maintenance object devices 720 that are associated with respective different monitoring object devices 710 that have caused the triggers.

Then, the maintenance management information acquiring unit 62 acquires, from the maintenance system 4, maintenance management information of the first maintenance object device 720 that is identified by the identifying unit 63 (step S55). If a plurality of maintenance object devices 720 are identified in step S53, the maintenance management information acquiring unit 62 may acquire maintenance management information of each of the maintenance object devices 720 that are identified.

Then, the display control unit 64 makes the maintenance management information of the first maintenance object device 720 output to the display apparatus 510 in association with the trigger (step S57), and moves to step S39 described above. For example, the display control unit 64 may make an alert display to inform the occurrence of a trigger output to the display apparatus 510, and, in response to receiving an instruction to display the detail of the trigger in the alert display, may make the maintenance management information of the first maintenance object device 720 output to the display apparatus 510. The alert display may display the monitoring object device 710 that has made the trigger occurred, occurring time and contents of abnormalities.

The display control unit 64, according to the instruction to display the detail of the trigger, may make the maintenance information output to the display window of the maintenance system 4 out of the plurality of windows in the integrated user interface. For example, the display control unit 64 may make the display apparatus 510 display, using the plurality of windows, plural types of maintenance management information regarding one maintenance object device 720. In this case, the display control unit 64 may acquire, according to the trigger, various types of maintenance management information of the first maintenance object device 720 (as an example, the maintenance state of the maintenance object device 720, the maintenance history, and the equipment ledger etc.), and make the maintenance management information of the first maintenance object device 720 displayed on the display apparatus 510, switching the plurality of windows to display.

If a plurality of triggers are acquired at step S51 and maintenance management information of the plurality of maintenance object devices 720 is acquired at step S55, the display control unit 64 may make an alert display to inform the occurrence of each of the plurality of triggers output to the display. In response to receiving an instruction to display the detail of any of the triggers in the alert display, the display control unit 64 may make maintenance management information of the maintenance object device 720 associated with the monitoring object device 710 that has caused the trigger displayed. In response to a user instruction to switch the trigger whose detail is displayed, the display control unit 64 may make the information among the maintenance management information of the maintenance object devices 720 acquired at step S55 switched and displayed.

Note that, like in the first embodiment described above, the display control unit 64 may make monitoring information of the operating state of the first monitoring object device 710 output to the display apparatus 510, in association with triggers occurred according to monitoring results of the power state of the first monitoring object device 710. Also, the display control unit 64 may make monitoring information of the power state of the first monitoring object device 710 output to the display apparatus 510, in association with triggers occurred according to monitoring results of the operating state of the first monitoring object device 710.

According to the interruption processing described above, when triggers including the identification information of the first monitoring object device 710 are acquired from the energy management system 2 and/or the equipment monitoring system 3, the associated first maintenance object device 720 is identified, and its maintenance management information is output. Accordingly, using the maintenance management information of the monitoring object device 710 that has abnormalities caused in its power state/operating state, the monitoring object device 710 having abnormalities can be inspected, repaired, or replaced early.

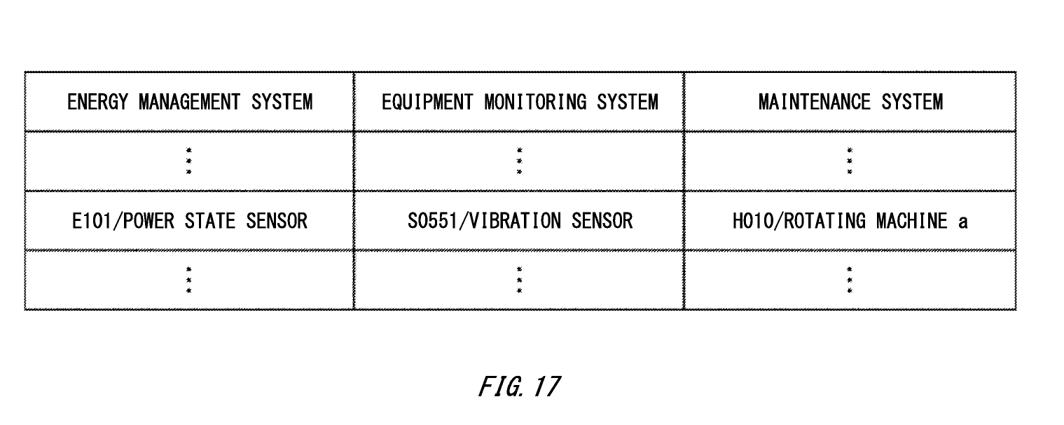

FIG. 17 illustrates an exemplary equipment database 60. For example, the equipment database 60 may store the power state sensor 101 as the monitoring object device 710 by the energy management system 2, the diagnosis unit 112 (a vibration sensor, as an example) as the monitoring object device 710 by the equipment monitoring system 3, and the equipment 110 (a rotating machine a, as an example) as the maintenance object device 720 by the maintenance system 4, associated with each other.

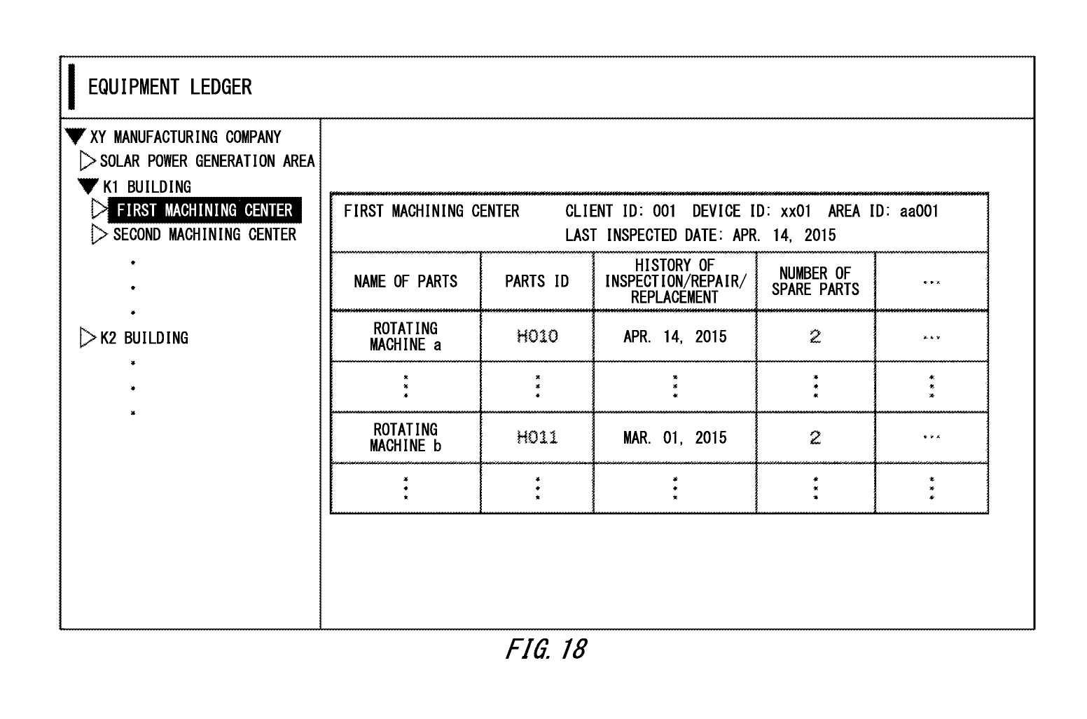

FIG. 18 shows a display of maintenance management information that is displayed in association with a trigger. When the detail display button 5105 is operated in the state shown in FIG. 11, the maintenance object device 720 associated with the monitoring object device 710 that has caused the trigger is identified, and its maintenance management information is output. FIG. 18 shows maintenance information of the first machining center as the maintenance object device 720.

Note that, in the embodiment described above, it has been described that the display control unit 64 supplies the various types of information to the display apparatus 510 to be displayed, but the display control unit 64 may make the display apparatus 510 actively acquire the information to be displayed. For example, the display control unit 64 may provide, to the display apparatus 510, the access information which includes the identification information of the energy management system 2 and the equipment monitoring system 3 and the identification information of the first monitoring object device 710, and make the display apparatus 510 acquire a display to display the monitoring information of the first monitoring object device 710 from the energy management system 2 and the equipment monitoring system 3. Similarly, the display control unit 64 may provide, to the display apparatus 510, the access information that includes the identification information of the maintenance system 4 and the identification information of the first maintenance object device 720, and make the display apparatus 510 acquire a display to display the maintenance information of the first maintenance object device 720 from the maintenance system 4. Thereby, the user can check the monitoring information and/or the maintenance management information on his/her own device. The display control unit 64 may make the display apparatus 510 allowed to acquire the display, by including, in the access information, authentication information to the energy management system 2, the equipment monitoring system 3 and/or the maintenance system 4.

Also, it has been described that the equipment management systems 1, 1A include the energy management system 2 and the equipment monitoring system 3, but the equipment management systems 1, 1A may include only either one of them.

Also, it has been described that the energy management system 2, the equipment monitoring system 3 and the maintenance system 4 have the database for monitoring power 20, the equipment database 30 and the maintenance database 40 respectively, but energy management system 2, the equipment monitoring system 3 and the maintenance system 4 may have common database to store contents obtained by integrating these database.

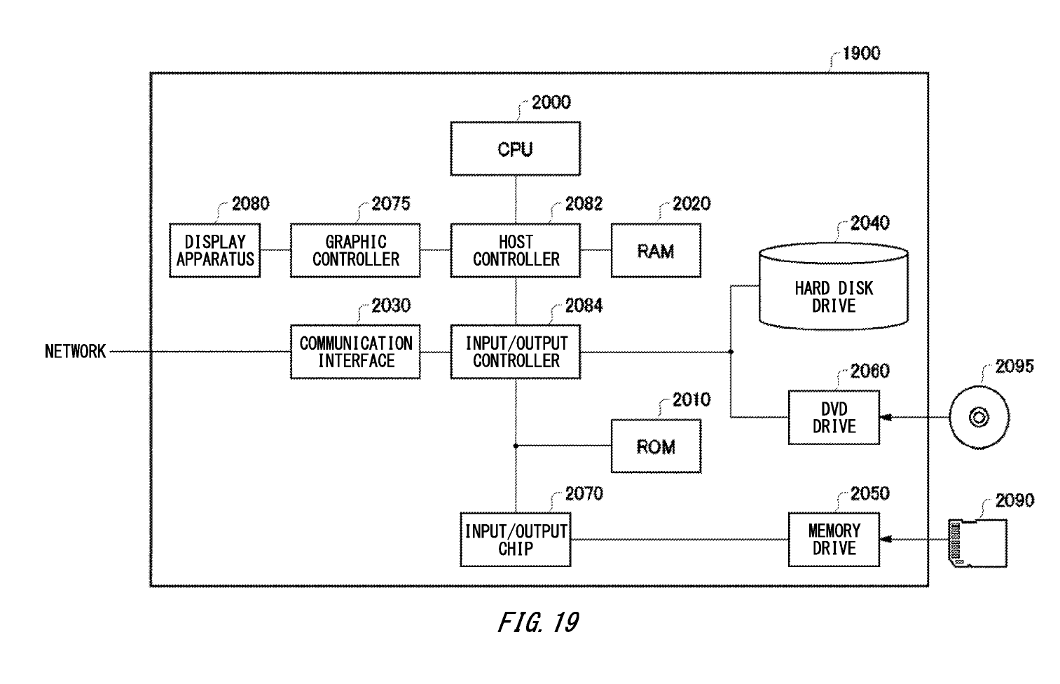

FIG. 19 illustrates an exemplary configuration of the computer according to the present embodiment. The computer 1900 according to the present embodiment functions as the equipment management systems 1, 1A or an element of the part thereof.

The computer 1900 according to the present embodiment includes: a CPU peripheral unit having a CPU 2000, a RAM 2020, a graphics controller 2075 and a display apparatus 2080 that are interconnected by a host controller 2082; an input/output unit having a communication interface 2030, a hard disk drive 2040 and a DVD drive 2060 connected to the host controller 2082 by an input/output controller 2084; and a legacy input/output unit having a ROM 2010, a flash memory drive 2050 and an input/output chip 2070 connected to the input/output controller 2084.

The host controller 2082 connects the RAM 2020, and the CPU 2000 and graphics controller 2075 that access the RAM 2020 at high transfer rates. The CPU 2000 operates based on a program stored on the ROM 2010 and the RAM 2020, and controls each unit. The graphics controller 2075 acquires image data to be generated on a frame buffer provided within the RAM 2020 by the CPU 2000 or the like, and displays the image data on the display apparatus 2080. Alternatively, the graphics controller 2075 may include therein a frame buffer that stores image data generated by the CPU 2000 or the like.

The input/output controller 2084 connects the host controller 2082, and the communication interface 2030, hard disk drive 2040 and DVD drive 2060 that are relatively high speed input/output apparatus. The communication interface 2030 communicates with other apparatuses via a wired or wireless network. Also, the communication interface functions as a hardware to perform the communication. The hard disk drive 2040 stores therein a program and data to be used by the CPU 2000 within the computer 1900. The DVD drive 2060 reads out a program or data from the DVD 2095, and provides them to the hard disk drive 2040 via the RAM 2020.

Also, the ROM 2010, and relatively low speed input/output apparatus of the flash memory drive 2050 and input/output chip 2070 are connected to the input/output controller 2084. The ROM 2010 stores therein a boot-program that the computer 1900 executes at the time of start-up and/or a program that is dependent on hardware of the computer 1900, or the like. The flash memory drive 2050 reads out a program or data from the flash memory 2090, and provides them to the hard disk drive 2040 via the RAM 2020. The input/output chip 2070 connects the flash memory drive 2050 to the input/output controller 2084, and also connects various types of input/output apparatus to the input/output controller 2084 via, for example, a parallel port, a serial port, a keyboard port, a mouse port or the like.

A program to be provided to the hard disk drive 2040 via the RAM 2020 is provided by a user by being stored on a recording medium such as the flash memory 2090, the DVD 2095, an IC card or the like. The program is read out from the recording medium, installed on the hard disk drive 2040 in the computer 1900 via the RAM 2020, and executed in the CPU 2000.

A program which is installed on the computer 1900 and make the computer 1900 function as at least part of the equipment management systems 1, 1A includes at least one of the following: an energy management system module, an equipment monitoring system module, a maintenance system module, a module for database for monitoring power, a power monitoring module, a power control module, a trigger generation module, an equipment database module, an equipment identifying module, a maintenance database module, a maintenance plan generating module, a display control module, a power state comparing module, a synchronization processing module, an equipment monitoring module, a diagnosis information acquiring module, an equipment management apparatus module, an equipment database module, an monitoring information acquiring module, a maintenance management information acquiring module, a identifying module, a registration information receiving module, a register processing module, and a hierarchy synchronization processing module. These programs or modules may act on the CPU 2000 or the like to make the computer 1900 function as: an energy management system 2, an equipment monitoring system 3, a maintenance system 4, database for monitoring power 20, a power monitoring unit 21, a power monitoring unit 21, trigger generating units 24, 35, equipment database 30, an equipment identifying unit 34, maintenance database 40, a maintenance plan generating unit 41, display control units 22, 33, 42, 51, 64, a power state comparing unit 52, a synchronization processing unit 53, an equipment monitoring module, a diagnosis information acquiring unit 310, an equipment management apparatus 6, equipment database 60, a monitoring information acquiring unit 61, a maintenance management information acquiring unit 62, a identifying unit 63, a registered information receiving unit 65, a registration processing unit 66, and a hierarchy synchronization processing unit 67, respectively.

Information processing described in these programs, by being read by the computer 1900, acts on the CPU 2000 or the like that is a specific mean where a software and the above-described various types of hardware resources work together, to make the computer 1900 function as the following: the energy management system 2, the equipment monitoring system 3, the maintenance system 4, database for monitoring power 20, the power monitoring unit 21, the power monitoring unit 21, trigger generating units 24, 35, equipment database 30, the equipment identifying unit 34, maintenance database 40, the maintenance plan generating unit 41, display control units 22, 33, 42, 51, 64, the power state comparing unit 52, the synchronization processing unit 53, the equipment monitoring module, the diagnosis information acquiring unit 310, the equipment management apparatus 6, equipment database 60, the monitoring information acquiring unit 61, the maintenance management information acquiring unit 62, the identifying unit 63, the registered information receiving unit 65, the registration processing unit 66, and the hierarchy synchronization processing unit 67. By realizing, with these specific means, calculation or processing on information corresponding to purposes of usage of the computer 1900 in the present embodiment, the specific equipment management systems 1, 1A corresponding to the purposes of usage is constructed.

In one example, if communication is performed between the computer 1900 and an external apparatus or the like, the CPU 2000 executes a communication program loaded onto the RAM 2020, and based on the processing contents described in the communication program, instructs the communication interface 2030 to perform communication processing. Under control of the CPU 2000, the communication interface 2030 reads out transmission data stored in a transmission buffer region or the like provided on a storage apparatus such as the RAM 2020, the hard disk drive 2040, the flash memory 2090 or the DVD 2095 to transmit the data to a network, or writes reception data received from a network into a reception buffer region or the like provided on a storage apparatus. In this manner, the communication interface 2030 may transfer transmission/reception data between storage apparatuses by the DMA (direct memory access) scheme, or alternatively, the CPU 2000 may transfer transmission/reception data by reading out data from a transfer source storage apparatus or communication interface 2030, and writing the data into a transfer destination communication interface 2030 or storage apparatus.

Also, the CPU 2000 causes all or necessary portions of files, databases or the like stored in an external storage apparatus such as the hard disk drive 2040, the DVD drive 2060 (DVD 2095) or the flash memory drive 2050 (flash memory 2090) to be read into the RAM 2020 by the DMA transfer or other schemes, and performs various types of processing on the data on the RAM 2020. The CPU 2000 writes the data on which processing has been performed back into an external storage apparatus by the DMA transfer or other schemes. Because in such processing, the RAM 2020 can be regarded as holding contents of the external storage apparatus temporarily, the RAM 2020 and the external storage apparatus or the like are collectively called a memory, a storage unit, a storage apparatus or the like in the present embodiment. For example, the equipment management systems 1, 1A may appropriately include a storage apparatus to store data of the present embodiment before, during, and after the processing.

Various types of information such as various types of programs, data, tables, databases or the like in the present embodiment are stored in such a storage apparatus, and are subjected to information processing. Note that the CPU 2000 can also hold a portion of the RAM 2020 on a cache memory, and read out from and write in the cache memory. Because in such an embodiment also, the cache memory plays a role of some of the functions of the RAM 2020, in the present embodiment, the cache memory is also regarded as being included in the RAM 2020, a memory and/or a storage apparatus unless otherwise they are distinguished from each other.

Also, the CPU 2000 performs, on data read out from the RAM 2020, various types of processing including various types of calculation, information processing, conditional decision, information search/replacement or the like described in the present embodiment that are specified in an instruction sequence of a program, and writes the data back into the RAM 2020. For example, when performing conditional decision, the CPU 2000 compares various types of variables shown in the present embodiment to decide whether they meet conditions such as being larger than, smaller than, equal to or larger than, equal to or smaller than other variables or constants, and if a condition is met (or if it is not met) branches to a different instruction sequence or calls up a subroutine.

Also, the CPU 2000 can search information stored in files, databases or the like in a storage apparatus. For example, if a plurality of entries in which attribute values of a second attribute are respectively associated with attribute values of a first attribute are stored in a storage apparatus, the CPU 2000 searches, from among the plurality of entries stored in the storage apparatus, an entry whose attribute value of the first attribute matches a specified condition, and reads out the attribute value of the second attribute stored in the entry, thereby being able to obtain the attribute value of the second attribute associated with the first attribute that meets a predetermined condition.

Also, when a plurality of elements are listed in the description of the embodiment, elements except the listed elements may be used. For example, when described as “X executes Y using A, B, and C”, X may execute Y using D, in addition to A, B, and C.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

1: Equipment management system; 2: Energy management system; 3: Equipment monitoring system; 4: Maintenance system; 5: Management unit; 6: Equipment management apparatus; 20: Database for monitoring power; 21: Power monitoring unit; 22: Display control unit; 23: Power control unit; 24: Trigger generating unit; 30: Equipment database; 31: Equipment monitoring unit; 33: Display control unit; 34: Equipment identifying unit; 35: Trigger generating unit; 40: Maintenance database; 41: Maintenance plan generating unit; 42: Display control unit; 50: Integrated database; 51: Display control unit; 52: Power state comparing unit; 53: Synchronization processing unit; 60: Equipment database; 61: Monitoring information acquiring unit; 62: Maintenance management information acquiring unit; 63: Identifying unit; 64: Display control unit; 65: Registered information receiving unit; 66: Registration processing unit; 67: Hierarchy synchronization processing unit; 100: Area; 101: Power state sensor; 110: Equipment; 112: Diagnosis unit; 113: Diagnosis information storage unit; 150: Network; 160: External server; 310: Diagnosis information acquiring unit; 400: Terminal device for maintenance; 510: Display apparatus; 710: Monitoring object device; 720: Maintenance object device; 5101: Operating state button; 5102: Trend button; 5103: Alarm button; 5111: Select button; 5104: Radio button; 5105: Detail display button; 1900: Computer; 2000: CPU; 2010: ROM; 2020: RAM; 2030: Communication interface; 2040: Hard disk drive; 2050: Flash memory drive; 2060: DVD drive; 2070: Input/output chip; 2075: Graphics controller; 2080: Display apparatus; 2082: Host controller; 2084: Input/output controller; 2090: Flash memory; 2095: DVD

What is claimed is:

1. An equipment management apparatus comprising:
equipment database to store an association relationship between a plurality of monitoring object devices that are monitoring objects for at least one of a power state and an operating state, and a plurality of maintenance object devices that are objects for maintenance management;
a monitoring information acquiring unit to acquire monitoring information indicating at least one of a power state and an operating state of a monitoring object device from a monitoring apparatus to monitor the plurality of monitoring object devices;
a maintenance management information acquiring unit to acquire maintenance management information of a maintenance object device from a maintenance management apparatus to perform maintenance management of the plurality of maintenance object devices;
an identifying unit to identify, using the equipment database, an association relationship between a first monitoring object device and a first maintenance object device out of the plurality of monitoring object devices and the plurality of maintenance object devices; and
a display control unit to make associated monitoring information of the first monitoring object device and maintenance management information of the first maintenance object device to be output to a display apparatus.

2. The equipment management apparatus according to claim 1, comprising:
a registered information receiving unit to receive, from the monitoring apparatus, registered information on a monitoring side which includes identification information of at least one monitoring object device that is newly registered as a monitoring object; and
a registration processing unit to register, to the equipment database, the at least one monitoring object device, based on the registered information on the monitoring side that is received.

3. The equipment management apparatus according to claim 2, wherein
the registration processing unit
associates the at least one monitoring object device with the at least one maintenance object device, if at least one maintenance object device associated with the at least one monitoring object device is already registered to the equipment database; and
registers the at least one monitoring object device to a new record in the equipment database, if the at least one maintenance object device associated with the at least one monitoring object device is not registered to the equipment database.

4. The equipment management apparatus according to claim 3, wherein the registration processing unit makes a user select the at least one maintenance object device among maintenance object devices that are not associated with any of the plurality of monitoring object devices, out of the plurality of maintenance object devices.

5. The equipment management apparatus according to claim 2, wherein
the registered information receiving unit receives, from the maintenance management apparatus, registered information on a maintenance side which includes identification information of at least one maintenance object device that is newly registered as an maintenance management object; and
the registration processing unit registers the at least one maintenance object device to the equipment database based on the registered information on the maintenance side that is received.

6. The equipment management apparatus according to claim 5, wherein
the monitoring apparatus manages database for monitoring to store information of the plurality of monitoring object devices;
the maintenance management apparatus manages maintenance management database to store information of the plurality of maintenance object devices; and
the registration processing unit
makes the maintenance management apparatus register, to the maintenance management database, a monitoring object device that is newly registered as a monitoring object to the database for monitoring of the monitoring apparatus; and
makes the monitoring apparatus register, to the database for monitoring, a maintenance object device that is newly registered as a maintenance management object to the maintenance management database of the maintenance management apparatus.

7. The equipment management apparatus according to claim 6, further comprising
a hierarchy synchronization processing unit to synchronize a first hierarchical structure of the database for monitoring and a second hierarchical structure of the maintenance management database, wherein
the database for monitoring stores the plurality of monitoring object devices in the first hierarchical structure; and
the maintenance management database stores the plurality of maintenance object devices in the second hierarchical structure.

8. The equipment management apparatus according to claim 1, wherein
the monitoring information acquiring unit acquires, from the monitoring apparatus, a trigger which includes identification information of the first monitoring object device out of the plurality of monitoring object devices;
the identifying unit accesses to the equipment database and identifies a first maintenance object device that is associated with the first monitoring object device out of the plurality of maintenance object devices;
the maintenance management information acquiring unit acquires, from the maintenance management apparatus, maintenance management information of the first maintenance object device that is identified by the identifying unit; and
the display control unit makes maintenance management information of the first maintenance object device output to the display apparatus in association with the trigger.

9. The equipment management apparatus according to claim 8, wherein
the display control unit
makes an alert display to inform occurrence of the trigger output to the display apparatus; and,
in response to receiving an instruction to display detail of the trigger in the alert display, makes maintenance management information of the first maintenance object device output to the display apparatus.

10. The equipment management apparatus according to claim 8, wherein
the display control unit
makes the display apparatus display, using a plurality of windows, a plural types of maintenance management information regarding one maintenance object device; and,
according to the trigger, makes maintenance management information of the first maintenance object device displayed on the display apparatus, switching the plurality of windows to display.

11. The equipment management apparatus according to claim 1, wherein
the maintenance management information acquiring unit acquires maintenance management information of the first maintenance object device out of the plurality of maintenance object devices;
the display control unit makes maintenance management information of the first maintenance object device output to the display apparatus;
in response to a user instruction to display monitoring information of a monitoring object device associated with the first maintenance object device when maintenance management information of the first maintenance object device is being output to the display apparatus, the identifying unit accesses to the equipment database and identifies the first monitoring object device that is associated with the first maintenance object device out of the plurality of monitoring object devices;
the monitoring information acquiring unit acquires, from the monitoring apparatus, monitoring information of the first monitoring object device that is identified by the identifying unit; and
the display control unit makes monitoring information of the first monitoring object device displayed on the display apparatus in association with maintenance management information of the first maintenance object device.

12. The equipment management apparatus according to claim 1, wherein the display control unit provides, to the display apparatus, access information which includes identification information of the monitoring apparatus and identification information of the first monitoring object device and makes the display apparatus acquire, from the monitoring apparatus, a display to display monitoring information of the first monitoring object device.

13. The equipment management apparatus according to claim 12, wherein the display control unit makes the display apparatus allowed to acquire the display by including authentication information to the monitoring apparatus in the access information.

14. The equipment management apparatus according to claim 1, wherein the display control unit makes configurable screen layout information to specify display contents, for each of a plurality of windows, displayed on the display apparatus.

15. The equipment management apparatus according to claim 14, wherein the display control unit makes it configurable to display, for at least one window of the plurality of windows, monitoring information of at least one monitoring object device out of the plurality of monitoring object devices, or maintenance management information of at least one maintenance object device out of the plurality of maintenance object devices.

16. The equipment management apparatus according to claim 14, wherein the display control unit makes it configurable to display, for at least one window out of the plurality of windows, information that is provided by an external server connected via an Internet.

17. The equipment management apparatus according to claim 16, wherein the screen layout information includes information indicating a web page address to acquire from the external server.
